(19) United States
(12) Patent Application Publication
(10) Pub. No.: US 2016/0196508 A1
(43) Pub. Date: Jul. 7, 2016

(54) BOOKING SYSTEM AND METHOD

(71) Applicant: FINE DINING EXPERIENCES UG, Berlin (DE)

(72) Inventor: Vivien RICHTER, Berlin (DE)

(21) Appl. No.: 14/915,706

(22) PCT Filed: Sep. 3, 2014
(86) PCT No.: PCT/EP2014/068718

§ 371 Date: Mar. 1, 2016

Related U.S. Application Data
(60) Provisional application No. 61/873,209, filed on Sep. 3, 2013.

(51) Int. Cl. G06Q 10/02; G06Q 50/12

(52) U.S. Cl. CPC G06Q 10/02; G06Q 50/12

(57) ABSTRACT

A method and system for storing, by a host server, in a ticket database, information related to a plurality of restaurants, the tickets containing an available status or an unavailable status. The method and system may display, by the host server, the tickets with the available status. The method and system may receive, by the host server, a request from the first user computing device to purchase a ticket with an available status. The method and system may receive, by the host server from the first user computing device, a cancelation request for the ticket and may resell, by the host server, the ticket to a second user computing device. The method and system may credit, by the host server, the payment for the ticket to the first user computing device.

### CROSS-REFERENCE TO RELATED APPLICATIONS

This application claims priority to U.S. Provisional Application Ser. No. 61/873,209, filed on Sep. 3, 2013, which is herein incorporated by reference in its entirety.

### TECHNICAL FIELD

Generally, the present disclosure relates to changing communication models between a business entity and a user. More particularly, the present disclosure relates to a system and method for purchasing a booking through a computing device.

### BACKGROUND

Customarily, guests ask for booking options by phone, email, and/or online for a specific date, time and/or table from a restaurant and/or any other business entity to book a specific number of seats. When using a phone call method to make the booking, the restaurant may inform the guest if the table is available and/or place the guest on a waiting list. A few disadvantages of this method may include: the guest may dial the wrong phone number, there may be a language barrier between the guest and the business entity, and/or there may be human error in entering the wrong date and/or time of the booking. Most of the time, the guest will not be informed about the current waiting list status and the chance to get the requested number of seats.

In another instance, a guest may email the restaurant and/or any other business entity and ask for a booking. A few disadvantages of this method may include: the guest not having access to full data for bookings, the method being too time consuming and costly for the guest and/or restaurant and/or any other business entity, and/or the system may be difficult to work with and not user friendly.

In some operations, a guest may use an online system to make a booking. The guest may check an online calendar for open tables, time and/or date of availability. A few disadvantages of this method may comprise: no personal contact, no transparency and/or the system may be difficult to operate.

Conventional booking systems create many disadvantages for guests. Most people like to reserve tables in advance, but they may reserve for instance in several restaurants for exactly the same date and time or they may not appear for their booking due to some conflicting event. For that reason, there are more no shows at restaurants, which translates into lost profits for restaurants and/or business entities. For example, fine dining restaurants deal with a profit-margin of less than 3-5% per table and lose money on guests who are not showing up for their booking. The average turnover for two guests can cost about $400.

Due to international markets changing continuously, restaurateurs and/or business entities are facing a lot of changes in their business models as well and have to overthink business processes completely over the next years if they want to keep their market positions. Accordingly, there is a need to address at least one of issues outlined the above. For this reason, it is necessary to implement business processes which include useful communication tools and new online methods, which can be integrated into the every day life of a restaurateur and/or business entity and user/guest. While certain aspects of conventional technologies have been discussed to facilitate the present disclosure, no technical aspects are disclaimed and it is contemplated that the claims may encompass one or more of the conventional technical aspects discussed herein.

### SUMMARY

An aspect of an example embodiment of the present disclosure is to provide a system and method for purchasing a booking through a computing device. This system may support both the restaurateur and/or business entity and the guest by changing communication models and optimizing the process of a booking. The system provides power, control, and transparency to restaurateurs and/or business entities, while still allowing guests flexibility in making bookings. The system is designed to help multiple groups of people including: the best agers, the youngsters, the concierges, the locals, the businessmen, the travelers, the culinary professionals, the VIPs, and/or any other category of people.

Best agers may look for easy to handle solutions, for a long time in advance and/or last minute bookings. Youngsters may want last minute bookings and maybe want a system which allows them to join their parents as walk in guests. Concierges make bookings for guests including last minute bookings for walk in guests. Locals may know the restaurant, and regularly reserve 1-2 weeks in advance if possible and/or request last minute bookings. Businessmen may have a need for last minute bookings which is planned by an assistant. Travelers may request a booking a long time in advance, may request last minute bookings, and/or want to be walk in guests. Culinary professionals may include: journalists, fine dining lovers, chefs and/or restaurateurs, food scientists, and/or cookbook writers. This group may prefer bookings made a long time in advance and/or last minute bookings. VIPs may be well connected to the restaurant and may always obtain a table and/or want last minute bookings.

The system may provide many options for restaurants and/or business entities, including: publishing tables to prospective guest, controlling transparency, avoiding no shows, dynamical pricing, managing social guest structure, profiting from common databases, and/or saving money among others. The system may additionally provide many options for guest, including: subscribing for preferred dates, organizing an interest list, receiving updates via push notifications, easy click and buy arrangements, peer to peer resale of a table, dining spontaneously, and saving time among others.

In one embodiment, a computer-implemented method and system comprise storing, by a host server in a ticket database, information related to a plurality of restaurants comprising tickets corresponding to bookings at restaurants, the bookings containing time and date information, the tickets containing an available status or an unavailable status; receiving, by the host server, a request from the first user computing device to purchase a ticket with an available status, the ticket corresponding to a booking at a restaurant, the ticket containing time and date information; upon receiving a transmission of payment instructions from the first user computing device, associating, by the host server, the ticket with the first user in the ticket database and changing the status of the ticket to unavailable; transmitting, by the host server to the first user computing device, the ticket to the first user; changing, by the host server, the status of the ticket in the ticket database to an unavailable status; receiving, by the host server from the first user computing device, a request to change the status of the ticket from unavailable to available in the ticket database; changing, by the host server, the status of the ticket from unavailable to available in the ticket database; receiving, by the host server, a request from a second user computing device to purchase the ticket; upon receiving a transmission of payment instructions from the second user computing device, associating, by the host server, the ticket with the second user in the ticket database and changing the status of the ticket to unavailable; and crediting, by the host server, at least a portion of the payment from the first user for the ticket to the first user computing device.

In another embodiment, a method and system comprise storing, by a host server in a ticket database, information related to tickets corresponding to events at a business, the events containing time and date information, the tickets containing an available status or an unavailable status, and storing, in a customer database, profile information for users that have purchased tickets; searching, by the host server, tickets in the ticket database with the available status during a predetermined period of time; receiving, by the host server from the entity server, a list of tickets with the available status and tickets with the unavailable status; searching, by the host server in the customer database, profile information for users that did not purchase tickets during the predetermined period of time; and posting, by the host server, tickets with the available status and sending push notifications to the computing devices of users that did not purchase tickets during the predetermined period of time regarding the tickets with the available status during the predetermined period of time.

In yet another embodiment, a method and system comprise storing, by a host server, in a ticket database, information related to a plurality of businesses comprising tickets corresponding to events at the businesses, the events containing time and date information, the tickets containing an available status or an unavailable status; receiving, by the host server from the first user computing device, a request to purchase a ticket with an available status within a timeframe determined by the first user, the ticket corresponding to an event at a business, the ticket containing time and date information; upon identifying a ticket in the ticket database with an available status for a time within the timeframe and upon receiving a transmission of payment instructions from the first user computing device, associating, by the host server, the ticket with an available status within the timeframe with the first user in the ticket database and changing the status of the ticket to unavailable; transmitting, by the host server to the first user computing device, the ticket to the first user; changing, by the host server, the status of the ticket in the ticket database to an unavailable status; receiving, by the host server from the first user computing device, a request to change the status of the ticket from unavailable to available in the ticket database; changing, by the host server, the status of the ticket from unavailable to available in the ticket database; upon changing the status of the ticket to available, automatically posting by the host server to computing devices of users, the ticket with the available status; receiving, by the host server, a request from a second user computing device to purchase the ticket; upon receiving a transmission of payment instructions from the second user computing device, associating, by the host server, the ticket with the second user in the ticket database and changing the status of the ticket to unavailable; and crediting, by the host server, at least a portion of the payment from the first user for the ticket to the first user computing device.

The present disclosure may be embodied in the form illustrated in the accompanying drawings. Attention is called to the fact, however, that the drawings are illustrative. Variations are contemplated as being part of the disclosure, limited only by the scope of the claims. The above and other features, aspects and advantages of the present disclosure will become better understood to one skilled in the art with reference to the following drawings, detailed description and appended claims.

### BRIEF DESCRIPTION OF THE DRAWINGS

The accompanying drawings, which are incorporated into and form a part of the specification, illustrate example embodiments of the present disclosure. Together with the detailed description, the drawings serve to explain the principles of the present disclosure. The drawings are only for the purpose of illustrating example embodiments of the present disclosure and are not to be construed as necessarily limiting the disclosure. Like numbers can refer to like elements throughout. The above and other aspects, advantages and features of the present disclosure will become better understood to one skilled in the art with regard to the following description, appended claims and accompanying drawings where:

FIG. 1 is a diagram of a network environment for creating a booking through a computing device according to an exemplary embodiment.

FIG. 2 illustrates method of creating a booking through a computing device according to an exemplary embodiment.

FIG. 3A illustrates a user interface for creating a booking through a computing device according to an exemplary embodiment.

FIG. 3B illustrates a user interface for creating a booking through a computing device according to an exemplary embodiment.

FIG. 3C illustrates a user interface for creating a booking through a computing device according to an exemplary embodiment.

FIG. 3D illustrates a user interface for transferring a booking through a computing device according to an exemplary embodiment.

FIG. 3E illustrates a user interface for creating a booking through a computing device according to an exemplary embodiment.

FIG. 3F illustrates a user interface for creating a booking through a computing device according to an exemplary embodiment.

FIG. 3G illustrates a user interface for a user profile for booking through a computing device according to an exemplary embodiment.

FIG. 4 illustrates method of selling a booking through a computing device according to an exemplary embodiment.

FIG. 5A illustrates a user interface for selling a booking through a computing device according to an exemplary embodiment.

FIG. 5B illustrates a user interface for selling a booking through a computing device according to an exemplary embodiment.

FIG. 5C illustrates a user interface for an overview of completed bookings on a user interface of a computing device according to an exemplary embodiment.

FIG. 5D illustrates a user interface for a booked ticket through a computing device according to an exemplary embodiment.

FIG. 5E illustrates a user interface for selling a booking through a computing device according to an exemplary embodiment.

FIG. 6 is a diagram for a booking processes, including payment and peer-to-peer transfer, through a network environment according to an exemplary embodiment.

### DETAILED DESCRIPTION OF THE PREFERRED EMBODIMENTS

The present disclosure will now be described more fully with reference to the accompanying drawings, in which example embodiments of the disclosure are shown. The disclosure may, however, be embodied in many different forms and should not be construed as being limited to the embodiments set forth herein. Rather, these embodiments are provided so that this disclosure will be thorough and complete, and will fully convey the concept of the disclosure to those skilled in the art.

The system may provide a platform where users may purchase and/or sell tickets for bookings and/or any other events. The system allows notifications to be sent to users who may be interested in receiving the tickets. Different users may receive different ticket notifications at different times based on their profile information and/or user status. The users may search for and purchase a ticket being resold by another user. The system also manages all payment and credit used to purchase and/or sell the tickets.

The system may allow business entities to manage interest lists. For example, restaurants may see who is interested in dining at their location and can filter people. Tables can be sent to interested guests and will be addressed as a post from the restaurant. Restaurants and/or business entities may decide when it is necessary to send out a new arrangement together with the post. Depending on the price structure at the restaurant and/or business entity the system may offer various pricing options as well as different tools for a sustainable pricing model. The system may allow tickets to be exchanged between customers, which may be limited to face value only.

In some implementations, a fee may be charged for each booking and/or booking which are included in the tickets and/or added to the user's shopping bag. Direct updates may be sent to guests with offers of demanded tables. Guest may be allowed to obtain tables spontaneous and last minute in the best restaurants all around the world. Guests may be able to resell their booked tickets directly with the system.

In some implementations, business entities and/or restaurants may be able to use behavioral targeting and may see their guest structure (business man, tourist, local) allowing guests feel more comfortable. The business entity and/or restaurants may plan targeted marketing actions. The business entity and/or restaurant may use more than one option, for example, to offer a table at a restaurant. In some implementations, tables may have flexible prices based on different dates and/or times. Business entities may create a price for the claims of every list, keep their pricing model more flexible (e.g., food costs, season, sustainability, staff, design objects etc.). In some implementations, the business entity and/or restaurant may have the option to decide, when making processes transparent and when professionally hiding them. In some implementations, the flexibility of system may allow the business entity and/or restaurant to address only those people, who are added to the “interest list”.

The system may be advantageous for the business entity and/or restaurant by: allowing a user to operate a barrier-free tool; creating an easy to use system which may easily synchronize with it on the backend and other backend systems (e.g., Opentable, Seatme, Livebookings); to be offered as a white label product and integrated into other market segments; allow the restaurant and/or business entity to control and transparency as needed and wanted; create flexible pricing models; avoid “no shows” and manage utilization; allow for spontaneous reactions fitting the situation and/or the transfer of responsibility to the guest side. The system may be advantageous for the guest by allowing a user to: buy tickets spontaneously; plan dining trips with the calendar; save searched interests with subscriptions; receive push notifications matching subscriptions; and/or to not get a “no” on the phone anymore when making booking.

Any verbs as disclosed herein can imply direct or indirect action or inaction. For example, when an element is referred to as being “on,” “connected” or “coupled” to another element, it can be directly connected or coupled to the other element or intervening elements may be present. In contrast, when an element is referred to as being “directly connected” or “directly coupled” to another element, there are no intervening elements present.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. It will be further understood that the terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

If any disclosures are incorporated herein by reference and such incorporated disclosures conflict in part or whole with the present disclosure, then to the extent of conflict, and/or broader disclosure, and/or broader definition of terms, the present disclosure controls. If such incorporated disclosures conflict in part or whole with one another, then to the extent of conflict, the later-dated disclosure controls. Hereinafter, the present disclosure will be described in detail with reference to the accompanying drawings.

As described herein, an application (or “app”) may be installed on a mobile computing device of a guest, patron, customer, and/or user. The application may communicate with a server through a communication network such as a local area network, Wi-Fi, cellular network, and/or any other communication network. The server may be hosted by a business establishment (e.g., a restaurant, bar, hotel, salon, airline, gas station) and/or a third party that can communicate with the business establishment and/or patron, customer, or user. The server may also communicate with payment systems, such as credit card processing systems or other banking systems to process payments. The “host server”, “entity server”, and/or a “host system” may be implemented interchangeably.

The business establishment may have a host system, which is a venue point of sale system that may communicate with a server of the business establishment and/or restaurant and/or may directly communicate with a third party, patron, customer, and/or user. The host system may be configured to open a tab and/or a ticket for each table, party, customer, patron, user, or other entity submitting a request for a product or service. The mobile device, one or more server, and the host system may be referred to herein as a system, which may also include other servers and databases to provide the described functionality.

The patron, guest, customer, and/or user may use a client computing device, such as a mobile phone, cellular phone, smartphone, personal data assistant, tablet computer, laptop computer, and/or other computing device that can connect to a communication network. For the purposes of this description, these terms may be used interchangeably.

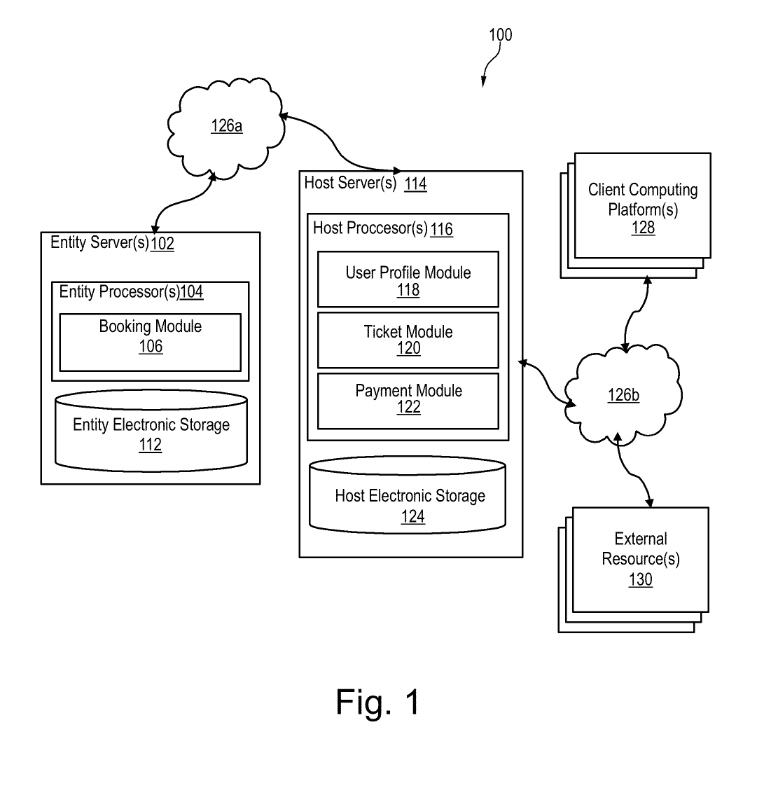

FIG. 1 illustrates a system 100 having an online marketplace configured for purchasing a booking through one or more computing devices. Inside the online marketplace, different participants are interacting with each other. The online marketplace can be a communication module stored on a computer readable medium and executed by a processor that transmits and receives information. The online marketplace may be used by many different entities and/or users. The term users may be interpreted and used interchangeably to describe restaurants, business entities, participants, guests, ticket sellers, ticket buyers, consumers and/or any other entity utilizing the system.

The online marketplace allows a booking of a capacity, including a reservation and/or a ticket. The system allows business entities to decide whether they want to issue a reservation and/or issue a ticket as well. However, the booking process may not require a reservation. For example, the users do not have to pay for a reservation and may provide a credit card number to hold their place at a restaurant and/or any other business entity. On the other hand, if the user chooses the ticket option in the booking process, then a ticket requires payment. Buying a ticket may include a reservation and/or personal user profile information. This may create a constant utilization, thereby allowing restaurants to be booked at their most efficient capacity, provide additional seating, and create higher revenue.

One particular type of user of the system 100 is a restaurant and/or any other business entity. The online marketplace helps eliminating guest and/or users who create “no-shows.” The online marketplace may allow bookings to only become available after the user creates a saved account with payment data and/or user profile information.

The online marketplace may also control transparency for business entities. For example, the restaurant can decide where and how posts will be made official and available to the user. The online marketplace may optimize processes for the restaurants and/or any other business entity. The system allows for manual booking control by staff members. Additionally, staff members can post reservations and/or tickets. The restaurant staff, being responsible for and interacting with the reservation management system, can save many hours everyday using the online marketplace described herein.

The online marketplace allows for selling online reservations and/or tickets. The restaurants and/or business entities may have a free choice regarding their position in the market, including: the ability to sell tickets, take reservations and walk-ins. The online market-place allows for private dining sales. For example, restaurants working with bookings may use their private dining rooms for ticket sales.

The online marketplace may provide a group booking assistant. For example, reservations with more than six persons will be assisted by group booking functionality that can automatically guide a user through a larger group booking, such as prepared menu choices for the group, automatic payment instructions, etc.

The online marketplace may provide an automatic cancelation and/or transfer service. For example, the online marketplace may comprise a waitlist management system where canceled reservations may be automatically filtered and addressed to potential interested diners. Tickets can be transferred to other diners inside the software and/or application. Tickets that are “ready for transfer” may be booked by interested diners.

The online marketplace may provide a flexible system for different restaurant types. For example, every restaurant may establish different perspectives and styles, such as French fine dining, counter restaurants, bistro style. Every type of restaurant may use the online marketplace as a base for their reservation management. In some implementations, the online marketplace may not charge per cover fees for restaurants. The service may charge a booking fee per booking from the guest and outsources these costs for restaurant bookings or allows the restaurant to include the booking fee inside their account. When a user resells a ticket through the marketplace, the user may be refunded the cost of the ticket except for the booking fee.

The online marketplace may provide user analysis tools, such as tracking and tagging of the user for better knowledge of preferences and/or restrictions. The online marketplace may provide integration of a restaurants widget for websites, social media platforms, mapping and navigation applications, service providers, and/or any other entity. In some implementations, only fine dining restaurants may obtain a position inside the marketplace. The online marketplace may provide a marketing channel for restaurants utilizing any search engine technologies, and provide multiple restaurants inside one system and/or app.

Another particular type of user of the system 100 is a guest and/or any other entity. The online marketplace may provide a social search engine with an update function. Locations based searching may provide a search for day and/or specific dates. The online marketplace may provide a search for a flexible time span during a day, and may save and/or update the search when for example, a subscription mode is activated. The online marketplace may provide dynamic subscriptions. For example, stream-lining subscriptions inside a newsfeed may help to manage the interest of a guest. Subscriptions may be location based on a particular day and/or time frame. Subscriptions may be location and/or date based for a period of time (e.g., Monday through Wednesday). Restaurants may see subscriptions inside their personal interest list.

The online marketplace may allow peer-to-peer ticket transfers. For example, purchased tickets may be transferred to other users inside the apps. Transferring a ticket may indicate a search technology for potential buyers of the tickets and send updates to stream-lined subscriptions. Saved payment data may help provide usability when guests want to pay for bookings. A user may allow checkouts with credit card and/or wallet solution.

The online marketplace may provide solutions to all users, including both restaurants and/or guests. The online market place provides a system which can be barrier free and as well white-labeled (e.g., licensed and outsourced to Google Maps or the Michelin Guide). All restaurants may be integrated and users are kept motivated for booking using the system. The system may provide the capability of using different languages and/or grant usability of the service. The system may provide the capability of using of multiple-currencies for payments.

The online marketplace provides users a tool to save a lot of time. Ticket sales and peer-to-peer ticketing may be offered to all event organizers (e.g., food festivals, forum discussions, awards, workshops, etc.). The online marketplace provides a flexible and expandable system.

This embodiment may incorporate any aspects of other implementations as described in the disclosure. In some implementations, system 100 may include one or more server(s) 102, 114. The server(s) 102, 114 may be configured to communicate with one or more client computing platform(s) 128 according to a client/server architecture. The users may access system 100 via client computing platform(s) 128.

In an exemplary embodiment, server 102 may be associated with a restaurant or other venue that is offering a booking. The server 114 may be associated with a booking host system, such as Fine Dining Experiences, which can provide the system functionality to the booking venues and the customers. The client computing platform 128 can be a customer or patron that desires to purchase, sell, reserve, transfer, or search for a booking.

In some implementations, server(s) 102, 114 may be configured to execute one or more computer program modules. The computer program modules may include one or more of a booking module 106, a user profile module 118, a ticket module 120, a payment module 122, and/or any other modules.

The booking module 106 may be configured to access and/or manage one or more bookings. Bookings may be made in numerous ways including through calling a business, emailing the business, and/or through software. The booking module 106 may manage any bookings comprising time, date, location, and service requested of a business.

The a user profile module 118 may be configured to access and/or manage one or more user profiles and/or user information associated with users of the system 100. The one or more user profiles and/or user information may include information stored by server(s) 102, 114, one or more of the client computing platforms 128, and/or other storage locations. The user profiles may include, for example, information identifying users (e.g., a username or handle, a number, an identifier, and/or other identifying information) within the virtual space, security login information (e.g., a login code or password), virtual space account information, subscription information, payment account information, relationship information (e.g., information related to relationships between users in the virtual space), usage information, demographic information associated with users, interaction history of the user with the system, information stated by users, purchase information of users, browsing history of users, a client computing platform identification associated with a user, a phone number associated with a user, and/or other information related to users.

A ticket module 120 may be configured to allow users to purchase tickets affiliated with the online marketplace system. In some implementations, the user may be provided a list of available tickets based on bookings to select. The booking may contain time, date, table, type of food, special requests and/or any other information. The user may select a booking and purchase a ticket corresponding to the booking using a client computing platform(s) 128.

The client computing platform(s) 128 may comprise a mobile application and/or any other type of interface application. The server(s) 102, 114 may use the ticket to search the point of sale system for the appropriate booking to display on the mobile application. Once a match is found, the ticket may be presented to the user on the mobile application for payment.

A payment module 122, may be configured to allow a user to make a payment directly through the client computing platform(s) 128. The client computing platform(s) 128 may comprise a mobile application. The mobile application may allow a user to make a payment in many different ways, including, virtual check, credit card, debit card, prepaid card and/or virtual currency. In some implementations, user may have promotional credit in their accounts which they can user instead of paying with real currency. In some implementations, the users may share this promotional credit with others, and/or just use it to pay for their own ticket.

The server(s) 102, 114, client computing platform(s) 128, and/or external resource(s) 130 may be operatively linked via one or more electronic communication links. For example, such electronic communication links may be established, at least in part, via a network 126a, 126b such as the Internet and/or other networks. It will be appreciated that this is not intended to be limiting, and that the scope of this disclosure includes implementations in which server(s) 102, 114, client computing platform(s) 128, and/or external resource(s) 130 may be operatively linked via some other communication media.

The entity and host server(s) 102, 114 may comprise electronic storage 112, 124, one or more processors 104, 116, and/or other components. The server(s) 102, 114 may include communication lines, or ports to enable the exchange of information with a network 126a, 126b and/or other computing platforms. The processors 104, 116 may be configured to execute computer program modules. The processors 104, 106 may be configured to execute the computer program modules via one or more of hardware, software, and/or firmware. The computer program modules may include booking module 106, a user profile module 118, a link module 120, a bill splitting module 122, and/or any other computer program modules. Although system 100 may be described in certain sections herein as including server(s) 102, 114, this is not intended to be limiting. The server(s) 102, 114 may be separate and distinct from system 100, and may be provided by an entity that is separate from, for example, the entity providing system servers. In some implementations, the functionality attributed herein to server(s) 102, 114 may be provided by system servers.

The server(s) 102, 114 may be incorporated on any point of sale and/or host system. The host system includes a processor in communication with a memory storing data, which includes the order and the payment account data. The host system can be an electronic cash register machine, which includes a credit card processing unit and cash storage. The host system can include a means for wired or wireless communication over a network. The means are in communication with the processor. For example, such means can be a dock, a port or an antenna. The host system can be linked to a website capable of receiving orders or processing payment. The host system can include a sensor for remote detection of the mobile device. The processor can be a single core, dual core, a multi-core or a system-on-chip. The memory can be random-access memory (RAM), virtual storage, real storage, cloud storage, flash memory or physical disk storage, such as an internal or external hard drive. The data stored in the memory can be encrypted and stored in the memory in an encrypted state. The data can be received in an encrypted state and then be decrypted, either on-the-fly or on-demand, and stored in a decrypted state in the memory.

A given client computing platform(s) 128 may include one or more processors configured to execute computer program modules. The computer program modules may be configured to enable an expert or user associated with the given client computing platform(s) 128 to interface with system 100 and/or external resource(s) 130, and/or provide other functionality attributed herein to client computing platform(s) 128. By way of non-limiting example, the given client computing platform(s) 128 may include one or more of a desktop computer, a laptop computer, a handheld computer, a tablet computing platform, a NetBook, a Smartphone, a gaming console, a mobile device and/or other computing platforms. The mobile device may include a processor in communication with a memory, an input means, such as a keyboard, a touchscreen or a microphone, and an output means, such as a display or a speaker. The mobile device can be a smartphone or a tablet computer.

The external resource(s) 130 may include sources of information, hosts and/or providers of virtual environments outside of system 100, external entities participating with system 100, and/or other resources. In some implementations, some or all of the functionality attributed herein to external resource(s) 130 may be provided by resources included in system 100. In some implementations, the point of sale and/or host system may be within external resource(s) 130. In some implementations, the host terminal may be located within server(s) 102, 114. A user may check-in by sending location information to a host system which includes a central processing unit (CPU) in communication with a memory and a display. The check-in can be wirelessly performed via direct communication with host system or via GPS, cellular network, Wi-Fi network, or a social networking service. The check-in can be performed via a wired technology as well. Upon successful check-in, the mobile device may appear as physically present in the business on the host system.

The server(s) 102, 114 may include electronic storage 112, 124, one or more processors 104, 116, and/or other components. The server(s) 102, 114 may include communication lines, or ports to enable the exchange of information with a network 126a, 126b and/or other computing platforms. Illustration of server(s) 102, 114 in FIG. 1 is not intended to be limiting. The server(s) 102, 114 may include a plurality of hardware, software, and/or firmware components operating together to provide the functionality attributed herein to server(s) 102, 114. For example, server(s) 102, 114 may be implemented by a cloud of computing platforms operating together as server(s) 102, 114.

Electronic storage 112, 124 may comprise electronic storage media that electronically stores information. The electronic storage media of electronic storage 112, 124 may include one or both of system storage that is provided integrally (i.e., substantially non-removable) with server(s) 102, 114 and/or removable storage that is removably connectable to server(s) 102, 114 via, for example, a port (e.g., a USB port, a firewire port, etc.) or a drive (e.g., a disk drive, etc.). Electronic storage 112, 124 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 112, 124 may include one or more virtual storage resources (e.g., cloud storage, a virtual private network, and/or other virtual storage resources). Electronic storage 112, 124 may store software algorithms, information determined by processor(s) 104, 116, information received from server(s) 102, 114, information received from client computing platform(s) 128, and/or other information that enables server(s) 102, 114 to function as described herein.

Processor(s) 104, 116 is configured to provide information processing capabilities in server(s) 102, 114. As such, processor processor(s) 104, 116 may include one or more of a digital processor, an analog processor, a digital circuit designed to process information, an analog circuit designed to process information, a state machine, and/or other mechanisms for electronically processing information. Although processor(s) 104, 116 is shown in FIG. 1 as a single entity, this is for illustrative purposes only. In some implementations, processor(s) 104, 116 may include a plurality of processing units. These processing units may be physically located within the same device, or processor(s) 104, 116 may represent processing functionality of a plurality of devices operating in coordination. The processor(s) 104, 116 may be configured to execute modules 106, 118, 120, 122, and/or any other modules. Processor(s) 104, 116 may be configured to execute modules 106, 118, 120, 122, and/or any other modules by software; hardware; firmware; some combination of software, hardware, and/or firmware; and/or other mechanisms for configuring processing capabilities on processor(s) 104, 116.

It should be appreciated that although modules 106, 118, 120, 122, and/or any other modules are illustrated in FIG. 1 as being co-located within a single processing unit, in implementations in which processor(s) 104, 116 includes multiple processing units, one or more of modules 106, 118, 120, 122, and/or any other modules may be located remotely from the other modules. The description of the functionality provided by the different modules 106, 118, 120, 122, and/or any other modules described below is for illustrative purposes, and is not intended to be limiting, as any of modules 106, 118, 120, 122, and/or any other modules may provide more or less functionality than is described. For example, one or more of modules 106, 118, 120, 122, and/or any other modules may be eliminated, and some or all of its functionality may be provided by other ones of modules 106, 118, 120, 122, and/or any other modules. As another example, processor(s) 104, 116 may be configured to execute one or more additional modules that may perform some or all of the functionality attributed below to one of modules 106, 118, 120, 122, and/or any other modules.

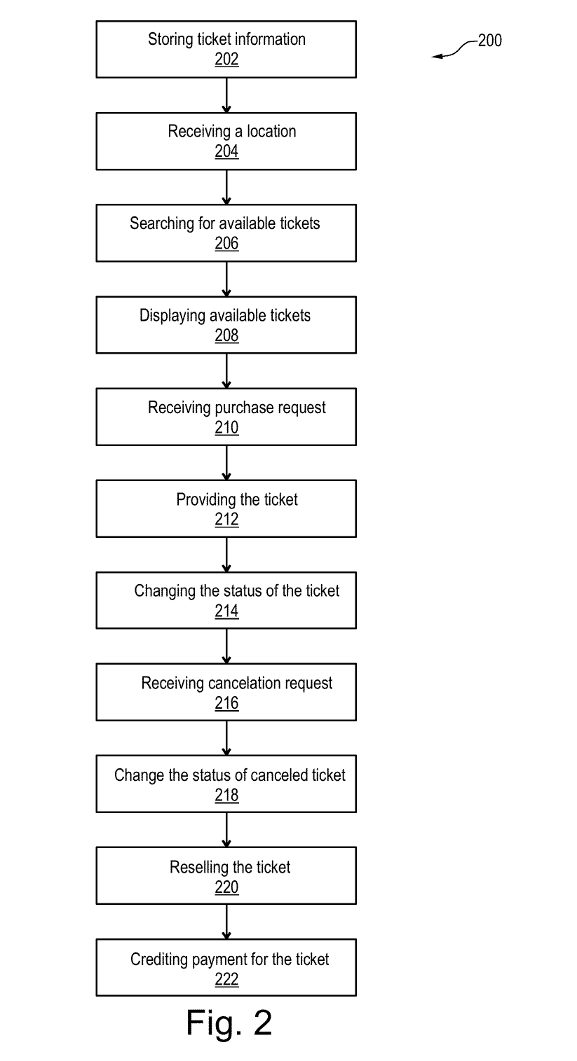

FIG. 2 illustrates method 200 of creating a booking through a computing device according to the present disclosure. This embodiment may incorporate any aspects of other implementations as described in the disclosure. The operations of method 200 presented below are intended to be illustrative. In some embodiments, method 200 may be accomplished with one or more additional operations not described, and/or without one or more of the operations discussed. Some elements of this figure are described above. Thus, any repetitive detailed description thereof will hereinafter be omitted or simplified in order to avoid complication. Additionally, the order in which the operations of method 200 are illustrated in FIG. 2 and described below is not intended to be limiting.

In some embodiments, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

At operation 202, the host server(s) 114 may store in a ticket database, information related to a plurality of restaurants and/or business entities comprising tickets corresponding to bookings at restaurants and/or business entities, the bookings containing time and date information, the tickets containing an available status and/or an unavailable status. In some implementations, the booking may include a table identification (ID) and/or any other ID. The booking may comprising a table selection indicating a table identification (ID) and a time and date of dining and selection of a service (e.g., pre-ordering a type of food).

In some implementations, the table selection may be based on displaying, by the server, a list of tables present in the business establishment to the first user and allowing the first user to select a particular table. The table ID may be based on a previous table selection made by the user when creating the booking. When a user purchases a ticket on the mobile application, the server may query the point of sale system for a list of tables present in the restaurant's database. The tables are presented to the user, who can then select which table they want to reserve. In some implementations, the table may be pre-selected for the user by the wait staff. The data to be queried may be stored in a database on the client electronic storage and/or the host electronic storage and/or any other storage location.

At operation 204, the host server(s) 114 may receive a location of a first user from the first user computing device. The first user computing device and/or second user may be a client computing platform(s) 128. In some implementations, determining the location of the first user may be based on a global positioning system. The approximate location of the computing device may be determined via data from the GPS receiver embedded in the client computing platform(s) 128 and/or data from the cell antenna tower (or towers) via which the computing device is communicating when ordering the ticket (e.g., within 150-50 meters, or less). For example, triangulation from multiple towers can provide fairly precise location data. In certain situations (e.g., where the user computing device is communicating via an antenna on or very close to the state border) it may be difficult to tell in which state the user mobile phone is located. Optionally, two or more methods may be used to identify a user location. For example, the system may receive a GPS reading (e.g., from a user terminal, such as a computer or cell phone equipped with a GPS receiver) and cell phone location information for a user. Similarly, the system may receive a GPS reading and an IP address associated with a user terminal, and use both types of information to verify the user's location.

In some implementations, the location may be based on user input. Optionally, to the extent the location data is ambiguous or there is uncertainty regarding the location of the computer terminal or phone, the system can transmit a notification to the user indicating that the system has not been able to verify the user's location. Similarly, the system may ask the user to input a location.

At operation 206, the host server(s) 114 may search in the ticket database for tickets with an available status corresponding to the bookings at restaurants and/or business entities in the vicinity of the location. The use of tickets is ubiquitous. Some form of a ticket, for example, is often required to view or attend an event, such as a sporting event, a theatrical production, a conference, a wine tasting, and the like. Tickets may also commonly be used as a booking mechanism, e.g., to secure a place on a flight, a cruise, a bus, and the like.

At operation 208, the host server(s) 114 may display on the first user computing device, the tickets with the available status. The tickets may be displayed in any form (e.g., special color and/or icon indicating an available status).

At operation 210, the host server(s) 114 may receive a request from the first user computing device to purchase a ticket with an available status, the ticket corresponding to a booking at a restaurant and/or any other business entity. The ticket may contain time and date information and/or any other pertinent information related to the booking. The request may be for a threshold period of time and/or during a time span. For example, a user may make a request for a booking by conducting location based searching. This may provide a search for day and/or specific dates. The online marketplace may provide a search for a flexible time span during a day, and may save and/or update the search when for example, a subscription mode is activated. The online marketplace may provide dynamic subscriptions. For example, stream-lining subscriptions inside a newsfeed may help to manage the interest of a guest. Subscriptions may be location based on a particular day and/or time frame. Subscriptions may be location and/or date based for a period of time (e.g., Monday through Wednesday). Other pertinent information may comprise: business entity name, the city of location of the business entity, a particular code referencing the booking, the number items reserved, the types of items reserved, and/or information relating to the upgrade policy. Upon receiving a transmission of payment instructions from the first user computing device, the host server(s) 114 may associate the ticket with the first user in the ticket database and changing the status of the ticket to unavailable.

At operation 212, the host server(s) 114 may transmit to the first user computing device, the ticket to the first user. The ticket module 120 may generate a ticket comprising the booking information. The ticket may be purchased with the user's payment account data using the payment module 122. The payment account data can be stored before the user checked-in, such as where user has a preexisting account in host system, or the payment account data can be stored after the check-in. The payment account data may be data that allows a vendor, such the restaurant, the bar, and/or any other business establishment, to place a charge onto an account associated with a domestic or a foreign financial institution. The account information may be accessed by the user profile module 118. Although typically, the account will be the account of the user of the mobile device, other accounts can be used as well. For example, a user of the mobile device may provide information of the account associated with the user's parent, a spouse, a child or a friend.

The payment account data can be credit card information, such as a credit card account number, a name associated with the credit card account, an expiration data and a security code. The payment account data can be debit card information, such as a debit card account number, a name associated with the debit card account and a personal identification number (PIN). The payment account data can be a gift card account data, such as a gift card number and a PIN. The payment data can be real or virtual currency or rewards points. The payment account data can be financial institution website login data or data stored on a website, such as a payment account data aggregator. In some implementations, the user may pay through a checking/savings account, debit card, credit card, and/or pre-paid card. For example, the user logs onto such website and manually inputs or imports the payment account data from the website into the software application. In some implementations, the software application is programmed to automatically login into the website, access the payment account data and either communicate the payment account data to the host system without permanently locally storing the payment account data or import the payment account data information into the software application and then transmit the payment account data to the host system.

The payment account data can be stored in or accessible via the memory of the client computing platform(s) 128. For example, the user manually inputs the payment account data into a software application running on the mobile device. The user can manually input the data before or after entry into the restaurant or the bar. Alternatively, the payment account data is stored in a NFC chip in communication with the mobile device, which includes the NFC chip. For example, a software application running on the mobile device accesses the payment account data stored on the NFC chip. Alternatively, the software application accesses the payment account data from a payment account data aggregator. The payment account data can be stored in another mobile device and the mobile device accesses another mobile device to retrieve/import the payment account data onto the mobile device. Alternatively, the payment account data can be stored remotely for remote access, such as via a website or web accessible service.

Upon access of the payment account data, the software application, directly or indirectly, communicates with the host system via the wireless or the wired means. If the software application is capable of directly communicating with the host system, then if the mobile device is present within a detection range of the host system, then the mobile device or the host system, either manually or automatically, detects the location/presence of the host system or the mobile device, respectively. If the software application is capable of indirect communication with the host system, such as over the Internet or cellular networks, then, upon the user's action, such as logging into a website or a service associated with the host system, the host system detects the presence of the mobile device.

The software application can be generic or specific to the restaurant, the bar and/or business entity. The software application can be a mobile application. For example, the restaurant has a software application specific to its host system. Thus, the user downloads and installs a specific software application for that host system. In order to properly operate, the specific software application requires a creation of an account, which requires entry of the payment account data. The payment account data can be manually entered, imported from an NFC chip or the memory or accessed via the Internet. Upon creation of the account and visiting of the restaurant, irrespective of the placement of the order, the user runs the specific software application, which communicates with the host and allows for display of information indicating the presence of the user.

At operation 214, the host server(s) 114 may change the status of the ticket in the ticket database to an unavailable status. The ticket database may be stored in the host electronic storage 124 and/or the entity electronic storage 112. The tickets may be displayed in any form (e.g., special color and/or icon indicating an unavailable status).

At operation 216, the host server(s) 114 may receive from the first user computing device, a cancelation request for the ticket. The first user computing device may be any client computing platform 128. When a cancelation request is made from the first user, the host server(s) 114 receives a request to change the status of the ticket from unavailable to available in the ticket database. At operation 218, the host server(s) 114 may store, the canceled ticket, and/or the ticket with the updated status in the ticket database.

At operation 220, the host server(s) 114 may resell the ticket to a second user computing device. The host server(s) 114 receives a request from a second user computing device to purchase the ticket. Upon receiving payment from the second user computing device, the host server(s) 114 associates the ticket with the second user in the ticket database and changing the status of the ticket to unavailable. In some implementations, the system may use push notifications to facilitate the resale of tickets. More specifically, the system may utilize push notifications to quickly communicate the availability of one or more tickets to potential buyers. When tickets become available for resale, the ticket reselling system may generate data to send a push notification, on a central server. Upon detecting the new data, the system may quickly display the data to an interested buyer, thereby facilitating the quick and efficient resale of the tickets. Similarly, when a buyer indicates a desire to purchase tickets for a particular event, the system may quickly display a push notification to one or more ticket holders or a vendor that may have tickets for resale.

In some implementations, the host server(s) 114 may send push notifications to a plurality of users containing information related to tickets with an available status. The push notifications may consist of sending incentives comprising: points, coupons, and virtual currency. The push notifications may be sent based on targeting users based on their user profile. Push notifications may use a constantly-open IP connection to provide notifications from servers (e.g., notifications related to third party web applications or browser extensions) to client computing devices (e.g., smart phones used by users who have installed the web applications or browser extensions). The notifications may include sounds, images, or custom text alerts, for example.

In some implementations, an active notification may include a feature to immediately alert a user, such as a sound alert, a desktop alert, a pop-up window, or animation. Passive notifications, in contrast, may operate in a background of a web browser for example. A passive notification may include an indicator or information shown in a web browser, such as near a web application icon in the browser.

In some implementations, the first user may resell the ticket to the second user and receive a commission. The first user may send a notification to the second user through using any form of communication, including email, push notification, MMS, SMS, phone call, and/or any other method. In some implementations, the system may resell the ticket to the second user and the first user pays a commission. When the user makes a selection, the value associated with that selection may be incorporated into the calculation of the commission. In some implementations, the commission may be calculated based on a percentage of the ticket. In some implementations, the commission may be variable. For example, the commission may be a higher fee and/or percentage the closer to the event time. In some implementations, the commission may be a fixed fee.

At operation 222, the host server(s) 114 may credit at least a portion of the payment from the first user for the ticket to the first user computing device. In some implementations, the payment may be based on the commission and/or any other fees charged to use the system. In some implementations, the credit may issue a direct refund to the first user's payment method. In some implementations, the credit may be in the form of virtual currency and/or points affiliated with the first user's account and/or any other form of credit.

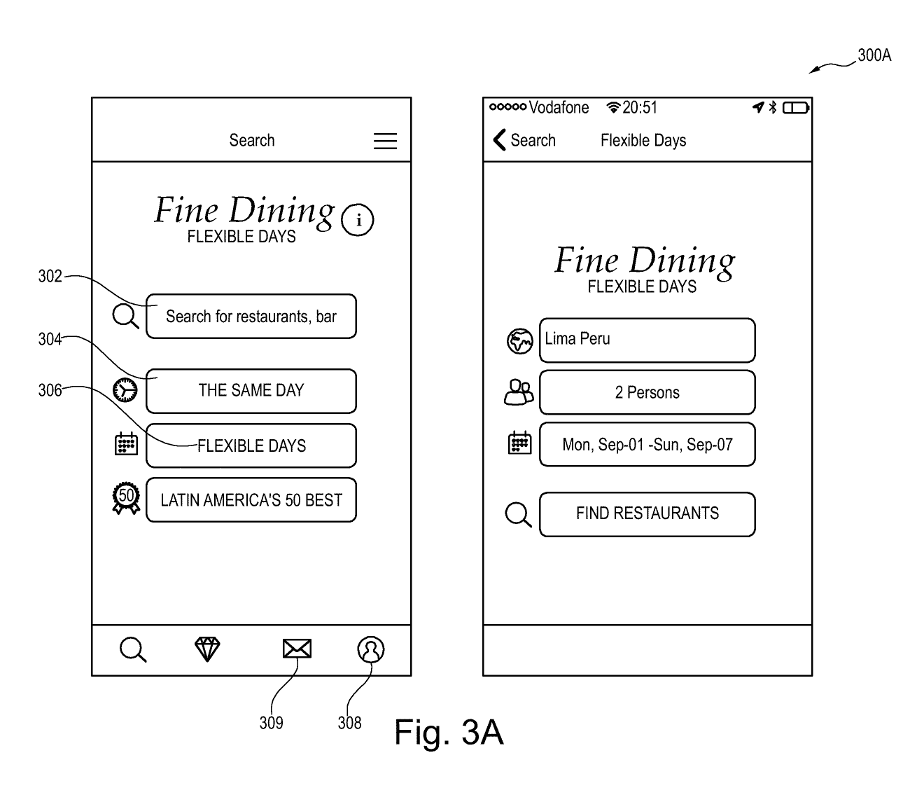

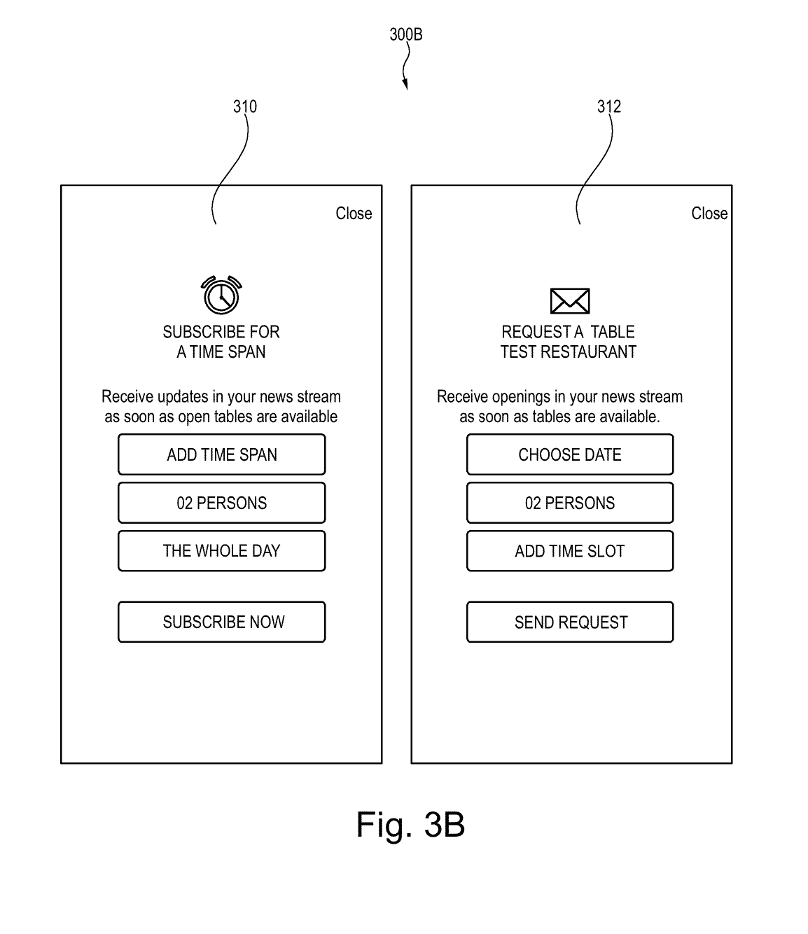

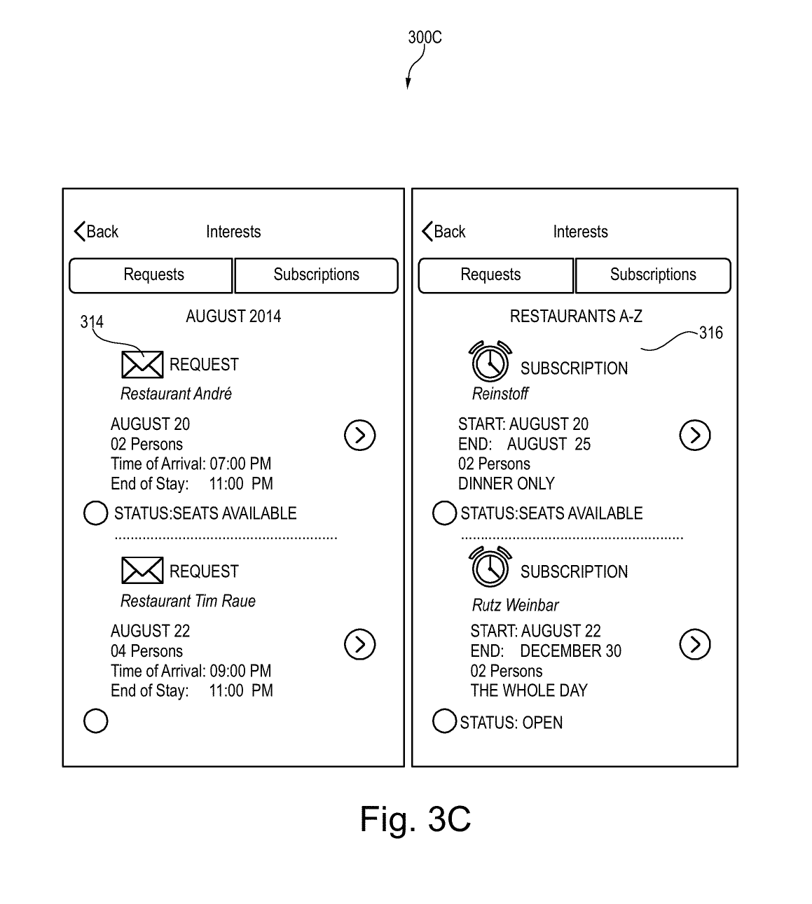

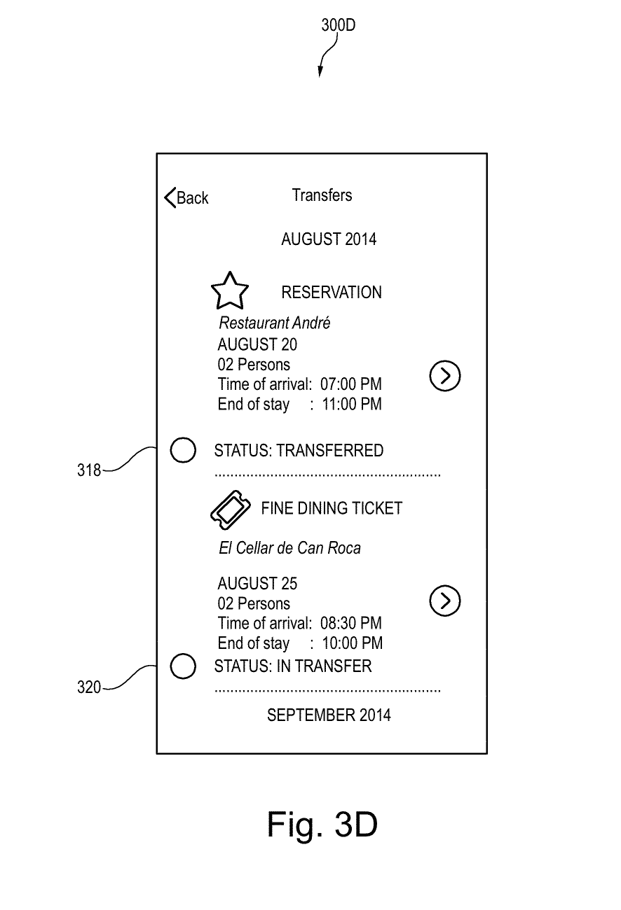

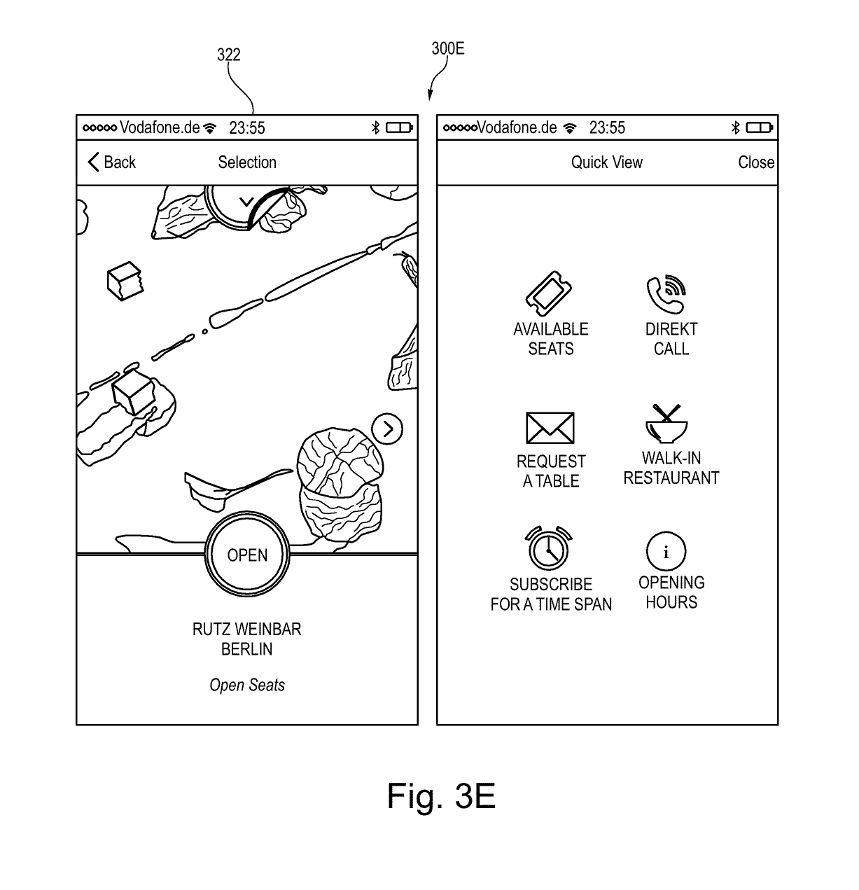

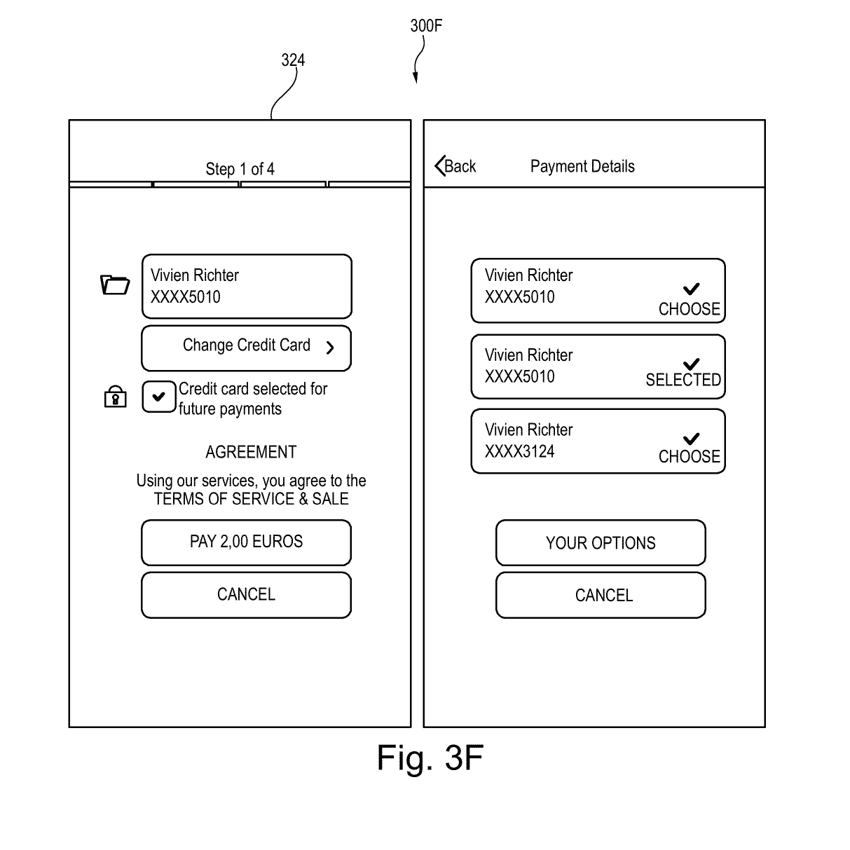

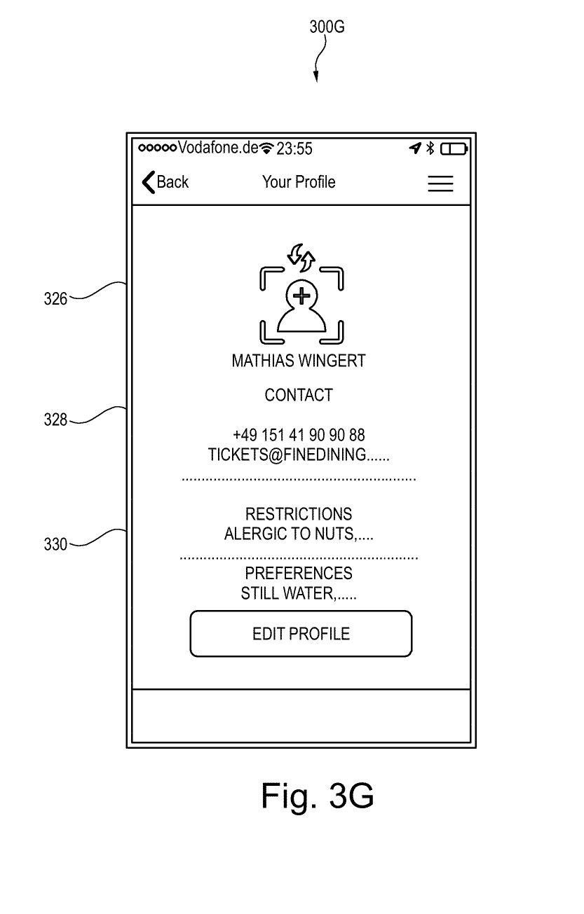

FIGS. 3A-3G illustrates a user interface 300 for purchasing a booking through a computing device according to the present disclosure. This embodiment may incorporate any aspects of other implementations as described in the disclosure. The operations of method 300 presented below are intended to be illustrative. In some embodiments, method 300 may be accomplished with one or more additional operations not described, and/or without one or more of the operations discussed. Some elements of this figure are described above. Thus, any repetitive detailed description thereof will hereinafter be omitted or simplified in order to avoid complication. Additionally, the order in which the operations of method 300 are illustrated in FIGS. 3A-3G and described below is not intended to be limiting.

In some embodiments, user interface 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of user interface 300 in response to instructions stored electronically on an electronic storage medium. The one or more processing devices may include one or more devices configured through hardware, firmware, and/or software to be specifically designed for execution of one or more of the operations of user interface 300. For example, the client computing device that displays the user interface may be a smart phone, mobile phone, personal data assistant, tablet computer, laptop computer, personal computer, or the like.

FIG. 3A illustrates a user interface 300A for purchasing a booking through a computing device according to the present disclosure. For example, the user is a traveler in Lima, Peru, and has experienced the city a whole day. It is 4:30 pm, and the traveler and the accompaniment are sitting in a café, thinking about where to dine that evening. The user has heard of some really great restaurants, however, all of these restaurants are fully booked. The user does not have any idea how to get a reservation. The user may check their mobile phones and look for some interesting restaurants around them, however, without knowing the name of the restaurant, it would not be possible to find out if there is a table available. Furthermore, the best and most interesting restaurants may not use online mobile apps for last minute bookings. One solution to the user's problem is purchasing tickets sold in the system which correspond to bookings of surrounding restaurants.

In some implementations, the user can search for a restaurant and/or business entity 302. Field 302 allows the user to enter the name of a restaurant, bar, or other entity name. The user interface contacts the host system and retrieves the request restaurant profile and provides every open table or other information requested by the user.

In an alternative embodiment, the user may choose a location-based search. The location may be automatically detected by the system and/or the location may be input by the user. The location may be automatically determined by any type of global positioning system (GPS) and/or any other method (i.e., cell ID, Wi-Fi, Bluetooth, inertial sensors, barometers, radio-frequency identification (RFID), near-field communication (NFC), and/or terrestrial transmitters) of determining a location from a client computing device.

In some implementations, the user may choose a destination based search. Using the system described herein, the user may be able to search for restaurant near the user and/or search for restaurants at a special location, for a specific time span. In some implementations, the system may be linked to the user's calendar, and recognize where the user will be in the future to conduct a search and/or recommendation. The search may be based on dates selected for the future by the user. The user may enter information such as: number of diners, a time span for the dinner, star rating of the restaurant, type of cuisine, and/or any other information related to allowing a user to choose a restaurant and/or business entity.

In some implementations, the user may search for a specific location, city, worldwide, or a location situated “near me” as well as a time within a particular timeframe (e g, minutes, hours, days, weeks), such as by using a same day search 304 and/or a flexible days search 306. The same day may comprise a timeframe in that one particular day. If no table is available that day, a user may make a request using a timeframe for that one day. The timeframe provides more flexibility for the user to obtain the table. The user may obtain a booking anywhere within that timeframe. The same day search is flexible for any time the user is given within that timeframe. The flexible search may provide additional options.

For example, if a user wants to travel to Lima and stay for a week, the user may inquire to know when there is a table available in Lima during the entire week. The user may receive subscription updates from the business entity (e.g., restaurant) for that week when a table is available. The flexible days search creates a timeframe which can be a span of hours, days, weeks, or months. The user may set a timeframe for either a particular restaurant and/or business entity in a city and/or region. The same day search and the flexible days search provide the user a benefit of creating a higher probability of the user obtaining a booking and remind the user of restaurants offering additional tables the user is interested in.

In some implementations, the user may be able to search for business entities based on any particular rating the business entity has received (e.g., star rating, Michelin Guide, The Good Food Guide, Gault Millau, Forbes Travel Guide, Zagat, Yelp, etc.) Users may additionally have the ability to rate the business entities and provide their ratings to other users.

The user may access user profile information 308. The user may further receive push notifications 309 for released tables their favorite restaurants, for the days the user is interested to dine at the restaurant based on their user profile information. The user may further save their exclusive seats online and book tables easily while they are traveling. The user may experience increased flexibility and host previously purchased tickets for resale with the app. The user may choose to transfer booked tickets (e.g., at face value only) and/or the system may anonymously find the a match for the user and manage the resale of the tickets, including a refund for the reseller, without a need to create a chargeback on the credit card. The system may receive a commission for selling reservations and tickets as well as transferring tickets. For example, the system may charge a fee for each booking and/or booking seat which are included in the tickets and/or added to your shopping bag. The system may send direct updates to their guests and offer them demanded tables. The system may further utilize restaurants much more efficiently. The user may additionally receive incentives. For example, the users may obtain tables spontaneous and last minute in the best restaurants all around the world. The guest may further resell their booked tickets directly with the app.

FIG. 3B illustrates a user interface 300B for creating a booking through a computing device according to the present disclosure. In some implementations, the user may choose to subscribe for a time span 310 (also referred to herein as a timeframe, time slot, and span of time) and/or request a table 312 for a particular day. A subscription may be an inquiry for a span of time greater than a single reservation and may last a few hours, days, weeks, or longer. For example, the user may subscribe for an entire day, a week, two weeks, and/or a month. This provides the user a greater probability of acquiring a table at a particular restaurant. In this exemplary embodiment, the user can choose a table for 2 people within a time slot of the whole day. The subscription allows the user to obtain a booking at any available time within the desired timeframe. In some implementations, a user may receive an immediate response to obtaining a booking through a subscription request (available, unavailable, check back at a later time, etc.) In some implementations, the business entity may reply to the user at a later time (e.g., when a time slot becomes available). The business entity may contact the user using any form of communication (e.g., phone call, email, SMS message, MMS message, etc.)

A request is an inquiry for a table on a particular day during a span of a few hours. The user may request a particular time and/or a timeframe. The user may additionally request a particular number of persons. In some implementations, a user may receive an immediate response to obtaining a booking through an inquiry request (e.g., available, unavailable, check back at a later time, etc.) In some implementation, the business entity may reply to the user at a later time (e.g., when a time slot becomes available). The business entity may contact the user using any form of communication (e.g., phone call, email, SMS message, MMS message, etc.)

FIG. 3C illustrates a user interface 300C for creating a booking through a computing device according to the present disclosure. The user may be able view inquiries (i.e., requests and subscriptions) already created and for use during the near future by the user. The user may be able to access tickets and/or reservations already created by the user for use at a future date. The user may view tickets available based on their search.

The user may view different booking options provided. The user can view available seats and/or requests 314 and subscriptions 316. All requests and subscription are sent to the restaurant and/or the business entity. A request may be a specific date and/or timeframe at a restaurant and/or business entity. A subscription may be for a longer period of time (e.g., 3 days, a week, a month). The user can see the status of different requests and/or subscriptions. For example, if the status is open, the user may view the inquiry, but might not yet be able to obtain a ticket and/or reservation. For example, the business entity may not accept reservations during a threshold period of time (e.g., more than six months in advance).

In some implementations, when the status shows that seats are available, the user can then use the system to make a booking. The user may select the available timeframe, view a seating chart to select seats, food, and/or any beverage to consume during the booking. Additionally, the user may submit any notes to the business entity. The notes may comprise any special requests (e.g., requesting special consideration for celebrating a life event) and/or any special needs (e.g., requiring any assistance for a handicap).

In some implementations, reminders may be sent to the user. The reminders may be pre-configured by the user and/or business entity. The reminders may request the user to confirm the booking.

FIG. 3D illustrates a user interface 300D for creating a booking through a computing device according to the present disclosure. The bookings may have different statuses (e.g., transferred, in transfer) that may be presented to the user. In some implementations, the user may be able to transfer their booking to other users and/or receive bookings transferred to them. When a booking has been successfully transferred to the user and/or a different user, the status may be displayed as transferred 318. For example, the user interface shows that a booking has been transferred from a first user to a second user and/or any other user. In some implementations, when the user is in the process of transferring the booking and/or receiving the booking, the status may be displayed as in transfer 320. For example, the user interface shows that a booking transfer is pending from a first user to a second user. In some implementations, users may receive requests for transfer from a first and/or second user. For example, the status may be displayed as transfer request. The first user may receive a request from a second user to transfer their booking. The first user may choose whether they prefer to keep their booking and/or transfer the booking to the second user.

FIG. 3E illustrates a user interface 300E for creating a booking through a computing device according to the present disclosure. In some embodiments, the user may be able to view details of restaurant and/or business entity 322. The user may be able to view available seats, request a table, subscribe for a time span, make a call to the restaurant, view walk-in availability, and view opening hours of the restaurant. In some implementations, the user may be provided additional information including the types of food, pictures of the food, special events, name of the chef, any food specials for the particular time frame, and/or any other information.

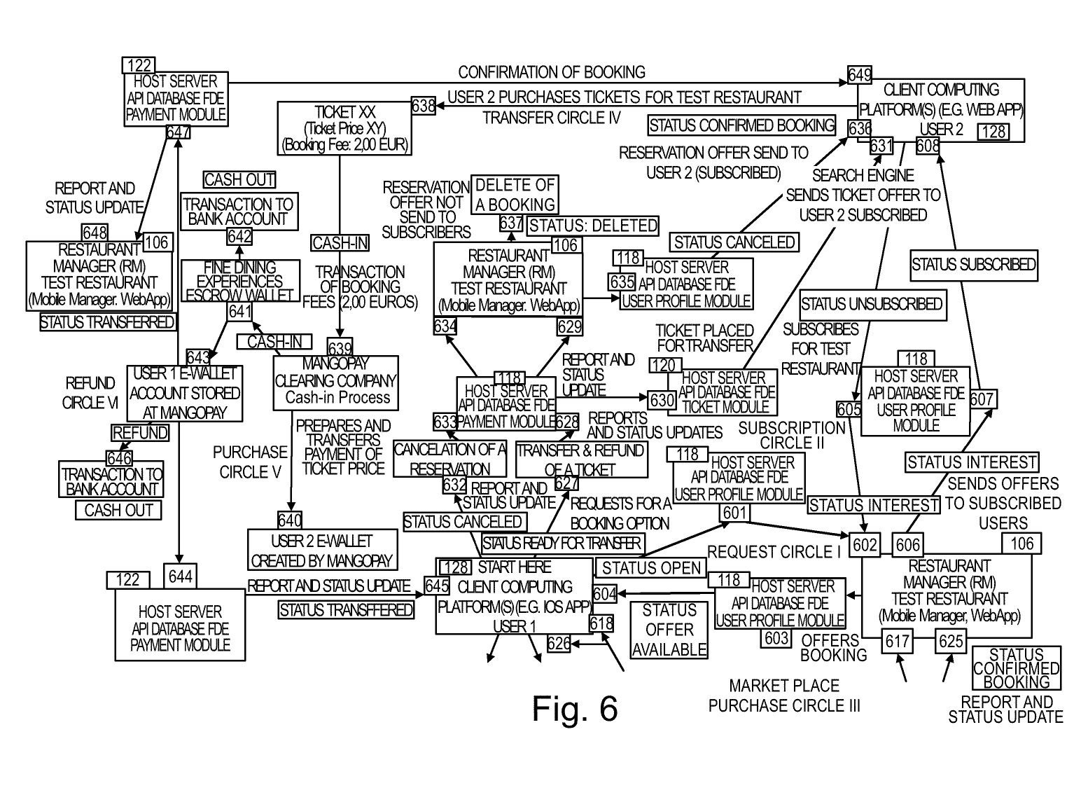

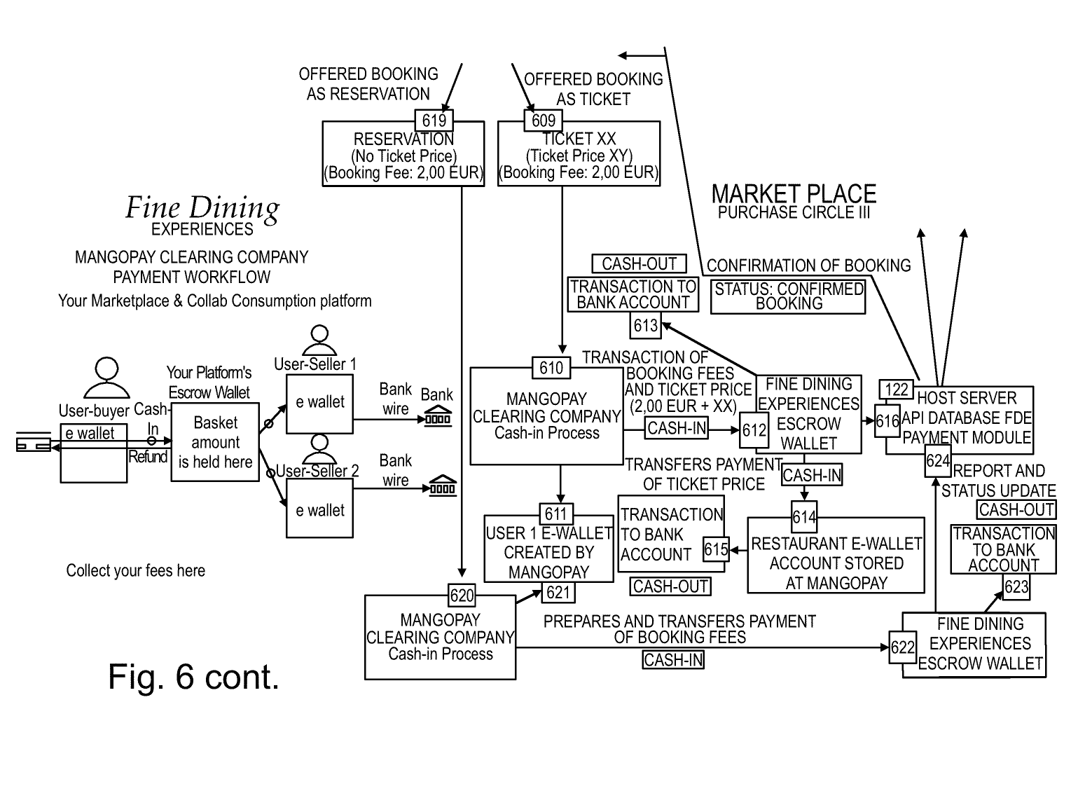

FIG. 3F illustrates a user interface 300F for purchasing a booking through a computing device according to the present disclosure. In some embodiments, the user may be able to select a payment mechanism 324 to pay for the tickets. Some methods of payment may be through a checking account, savings account, credit card, debit card, pre-paid card, stored value card, gift card, virtual currency, virtual points, and/or any other payment mechanism. In some implementations, more than one means of payment may be selected. In some implementations, payment information may be stored in the user account and/or user profile. Payment authorization and settlement is described in further detail below with respect to FIG. 6.

FIG. 3G illustrates a user interface 300G for purchasing a booking through a computing device according to the present disclosure. In some implementations, a user may create a user profile which may include the user's photo 326, the user's name 328, and/or the any information unique to the user 330. This information may provide the business entity and/or restaurant background information on the user so they may provide extra services and/or customize the experience to the user based on their profile. The user profile may indicate food allergies, birthday information, food and/or wine preferences, frequency of visits to the business entity and/or restaurant, member status, and/or any other information which may make the user's experience more pleasurable. The restaurant server may request this information from the host server upon establishing a booking with the user so that the booking of the user reflects the user's preferences.

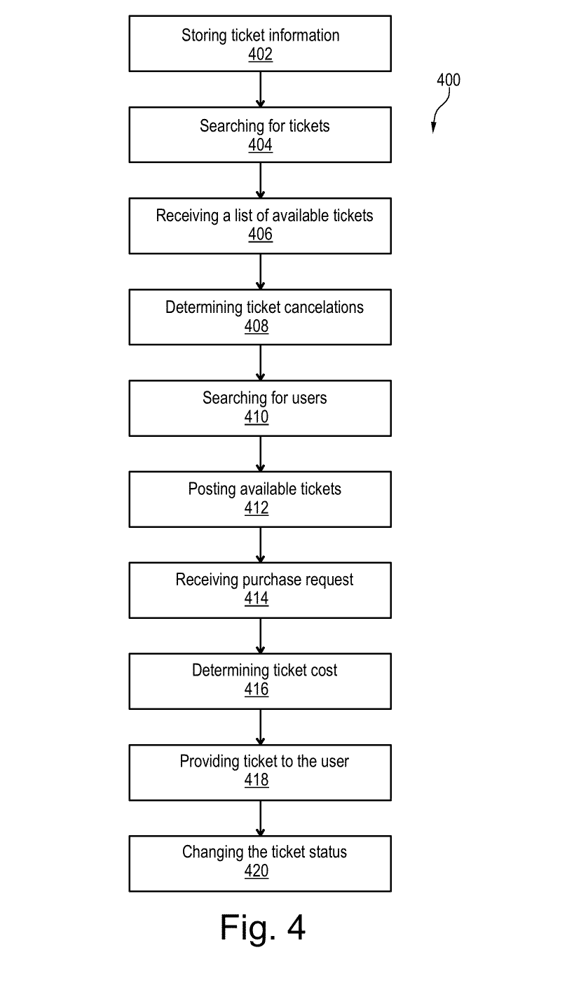

FIG. 4 illustrates method 400 of selling a booking through a computing device according to the present disclosure. This embodiment may incorporate any aspects of other implementations as described in the disclosure. The operations of method 400 presented below are intended to be illustrative. In some embodiments, method 400 may be accomplished with one or more additional operations not described, and/or without one or more of the operations discussed. Some elements of this figure are described above. Thus, any repetitive detailed description thereof will hereinafter be omitted or simplified in order to avoid complication. Additionally, the order in which the operations of method 400 are illustrated in FIG. 4 and described below is not intended to be limiting.

In some embodiments, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

At an operation 402, information related to tickets corresponding to events at a business, the events containing time and date information, the tickets containing an available status or an unavailable status may be stored in a ticket database by the host server(s) 114 in the ticket database. Profile information for users that have purchased ticket may also be stored in a customer database. In some implementations, the customer and/or ticket databases may be in the client electronic storage and/or the host electronic storage. In some implementations, the business may be one or more of: a restaurant, a tour guide, a bowling alley, a movie theater, a hotel, a rail-line, and/or an airline.

At an operation 404, tickets with the available status during a predetermined period of time may be searched in the ticket database. In some implementations, the predetermined period of time maybe input by the user (e.g., search during a particular time and/or date). In some implementations, the system may determine the predetermined period of time.

At an operation 406, a list of tickets with the available status and tickets with the unavailable status may be received by the host server(s) 114 from the entity server(s) 102. In some implementations available and/or unavailable tickets may be displayed. In some implementations, the available tickets may have a particular indicator (e.g., particular color, icon, etc.) which may be different than the unavailable tickets.

At an operation 408, ticket cancelations during the predetermined period of time may be determined. In some implementations, the restaurant and/or business entity may set a particular time when tickets which are canceled may not be sold for reimbursement. The predetermined period of time may set individually for each restaurant and/or business entity. The restaurant and/or business entity may make the predetermined period of time the same and/or different based on the user's profile information. For example, if a user is a valued customer, the restaurant and/or business entity may choose not to set a predetermined period of time for cancelations and allow the user to cancel and resell at any time. In another implementation, if the user is unknown and/or undervalued to the restaurant and/or business entity, a predetermined period of cancelation may be set.

At an operation 410, profile information and/or location information for users that did not purchase tickets during the predetermined period of time may be searched in the customer database by the host server(s) 114. In some implementations, the profile information may provide valuable marketing information to the restaurant and/or business entity. For example, the profile information may determine which users prefer the specific type of food offered by the restaurant and/or which users may be on the wait list for the restaurant and/or business entity. The location information may indicate whether the user is in town during the time of the booking.

At an operation 412, tickets with the available status and sending notifications to the users that did not purchase tickets during the predetermined period of time regarding the tickets with the available status during the predetermined period of time may be posted by the host server(s) 114 to a client computing platform(s) 128. The notifications may be push notifications, MMS, SMS, e-email, phone call, and/or any other type of notification. In some implementations, the system may determine the location of the users and send push notifications to a plurality of users which contain information related to tickets with an available status when the users are within a proximate vicinity of the business during the predetermined period of time. In some implementations, push notifications may consist of sending incentives comprising: points, coupons, bitcoins and/or virtual currency. The users may be able to pay for the services related to the tickets using points, coupons, virtual currency, bitcoins, and/or payment using real currency. In some implementations, push notifications may be sent based on targeting users based on their user profile. For example, users with a particular preference for a type of food and/or dish.

At an operation 414, a request from a first user to purchase a ticket with an available status may be received by the host server(s) 114. In some implementations, the request to purchase the ticket may comprise: the price of the tickets, an additional booking fee and/or a commission percentage.

At an operation 416, the cost of the ticket may be determined by the host server(s) 114. In some implementations, the cost may be based on the time the ticket was purchased or the type of user which purchased the ticket. In some implementations, time based purchases may comprise: early bird, last minute, and/or number of tickets purchased during a time period. In some implementations, the type of user may comprise: concierges, VIPs (e.g., those receiving special treatment due to a formal or informal status at the establishment), subscribers, foodies, business travelers, culinary professionals, and/or journalists.

At an operation 418, the ticket may be provided to the first user upon receiving payment for the ticket based on the cost of the ticket by the host server(s) 114. The ticket may be provided through email, SMS messaging, MMS messaging, QR code, physical tickets may be mailed, and/or by any other means of providing tickets.

At an operation 420, the status of the ticket may be changed in the ticket database to an unavailable status by the host server(s) 114. Upon receiving payment from the first user computing device, the host server(s) 114 may associate the ticket with the first user in the ticket database and change the status of the ticket to unavailable. In some implementations, the available tickets may have a particular indicator (e.g., particular color, icon, etc.) which may be different than the unavailable tickets.

The functionality described herein can be implemented by numerous modules or components that can perform one or multiple functions. Each module or component can be executed by a computer, such as a server, having a non-transitory computer-readable medium and processor. In one alternative, multiple computers may be necessary to implement the functionality of one module or component.

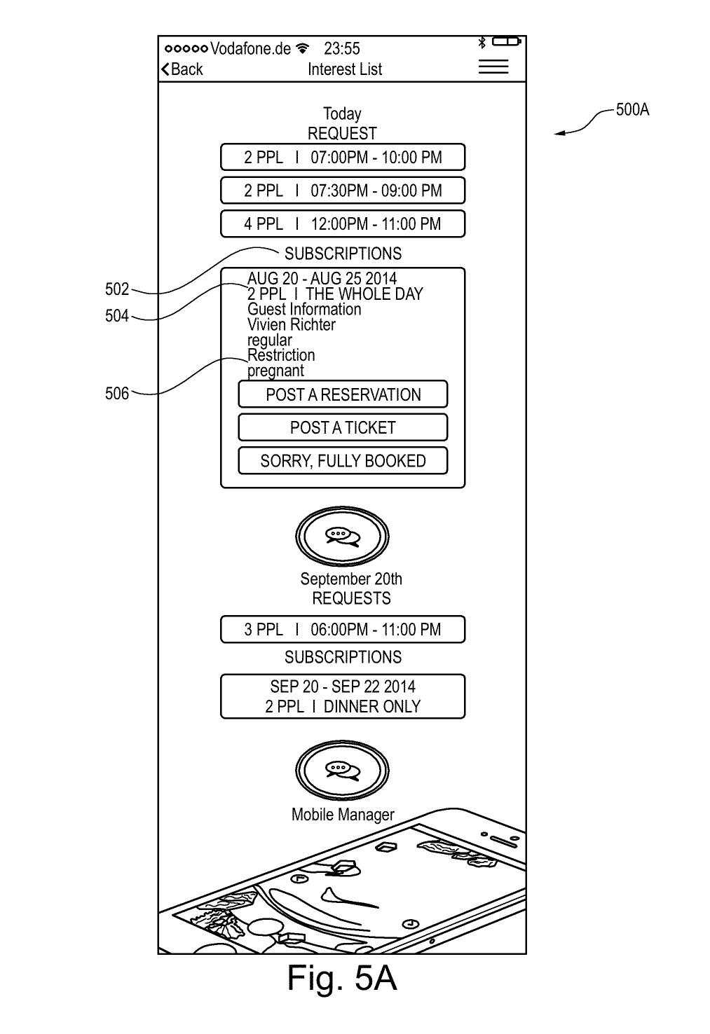

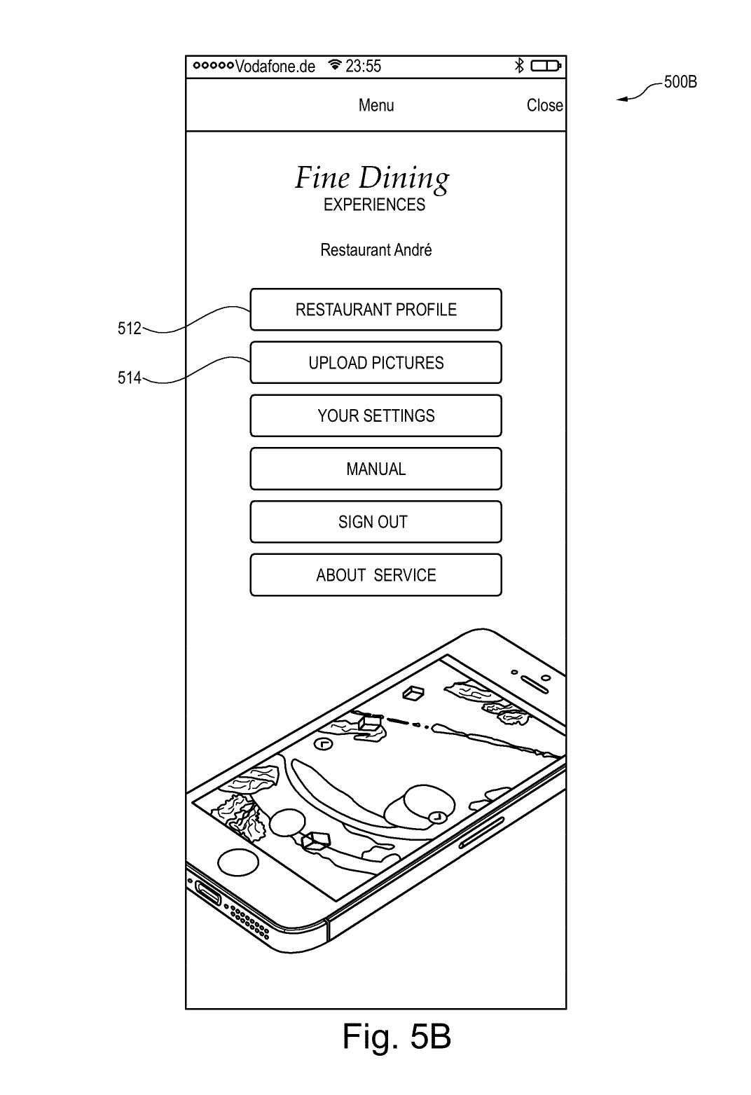

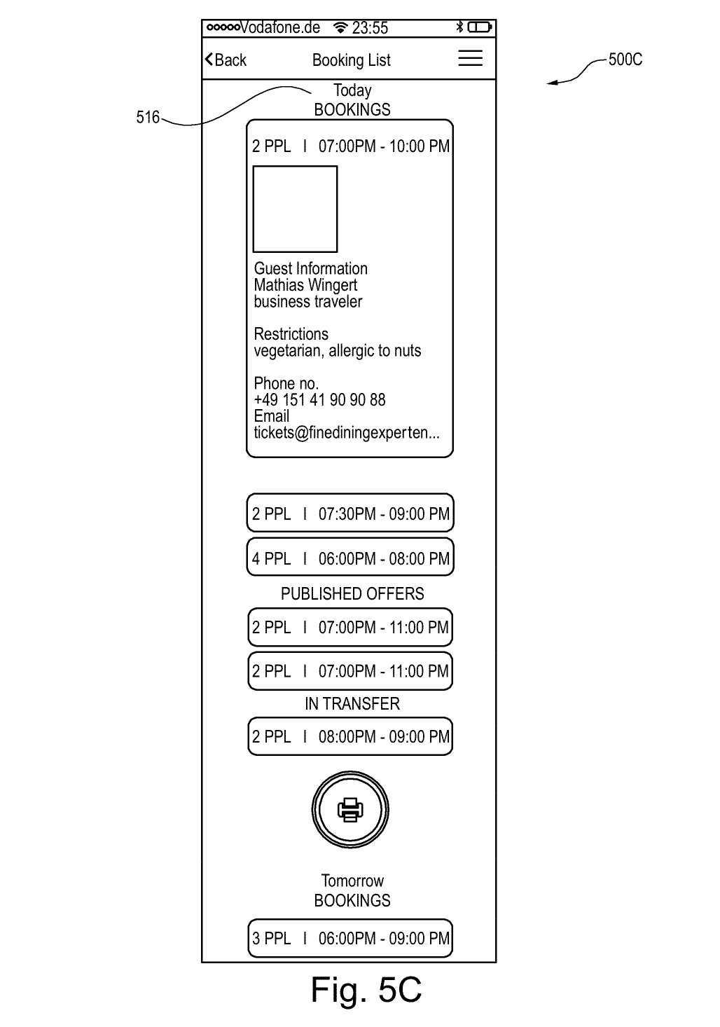

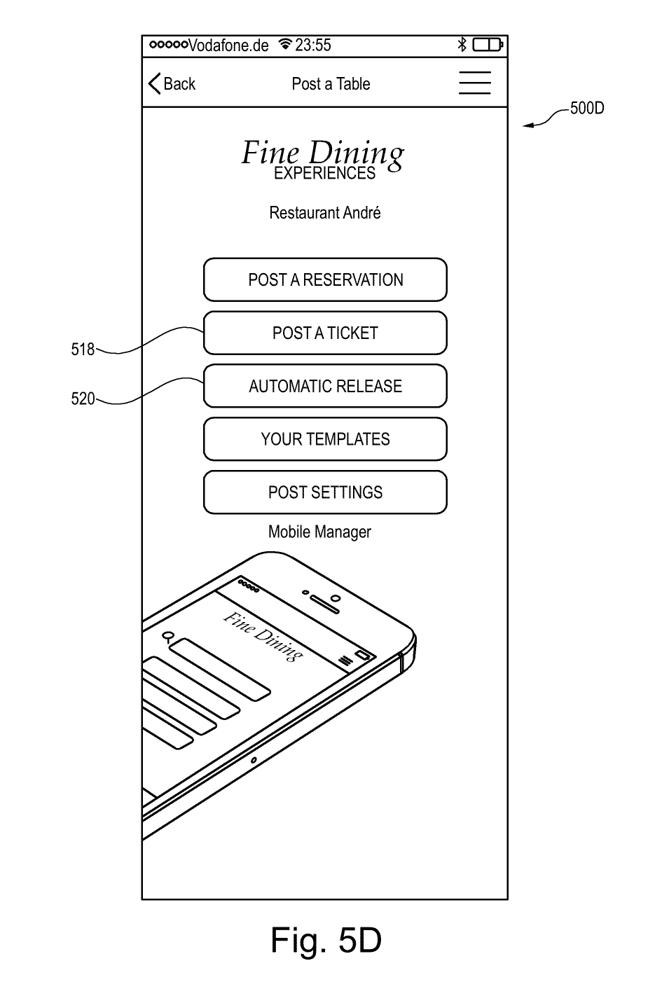

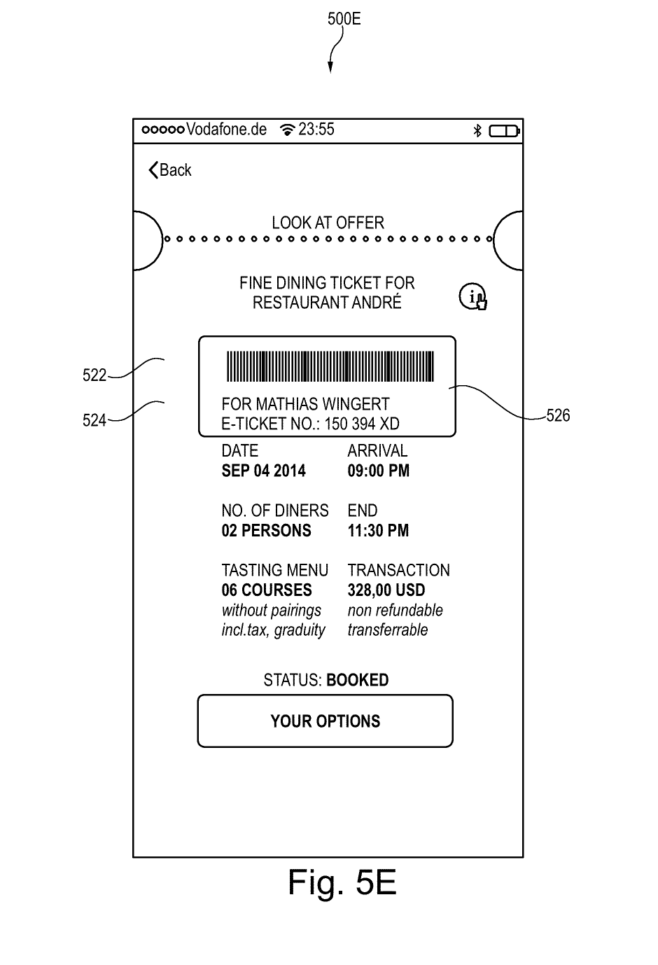

FIGS. 5A-5E illustrates a user interface 500 for selling a booking through a computing device according to the present disclosure. This embodiment may incorporate any aspects of other implementations as described in the disclosure. The user interface 500 presented below is intended to be illustrative.

In some embodiments, user interface 500 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of user interface 500 in response to instructions stored electronically on an electronic storage medium. The one or more processing devices may include one or more devices configured through hardware, firmware, and/or software to be specifically designed for execution of one or more of the operations of user interface 500.

FIG. 5A illustrates a user interface 500A for selling a booking through a computing device according to the present disclosure. In some implementations, the interface may provide information to the restaurant and/or business entity through different tabs which may include an interest list, may allow the entity to post a table, look at events, post events, and/or manage bookings. In some implementations, the interface in the interest list tab may present a list of diners, who subscribed and are interested to dine in the restaurant 502. The user interface may also display information collected from the location and destination based on the search 504. The user interface may additionally display information collected from user profiles 506, for example, diners celebrating a special occasion. The information provided in the user interface 500, allows the system to strategically market by send push notifications and/or contact users using any other method. In some implementations, restaurant and/or business entity may order a detailed report with analysis of first region, interested diners, location and/or destination based searches for every month. Information related to activities in the region of the restaurant and/or business entity may also be displayed (e.g., fairs, festivals, holidays, business people coming to town, season based analysis, and/or any other information). The report may be sent to a particular user via email, MMS, SMS, and/or the report may be printed. The user interface may additionally provide a means to post a table.

FIG. 5B illustrates a user interface 500 for selling a booking through a computing device according to the present disclosure. In some implementations, the user interface may allow the business entity options to manage the restaurant profile 512. The restaurant profile may include different information to provide the users (e.g., type of food, name of chef, specialties during a particular time frame, and/or any promotions). In some implementations, the user interface may allow the restaurant to upload pictures 514. The pictures may include types of food served by the restaurant, pictures of guests and/or pictures of the restaurant and/or business entity. Other options such as general settings, manual, sign out, and information about the service may additionally be provided.

FIG. 5C illustrates a user interface 500C for selling a booking through a computing device according to the present disclosure. In some implementations, the user interface may provide functionality for managing a booking list, including bookings, published offers, and bookings in transfer. Upon selection of any booking on the user interface, the user may see additional details on that particular booking or availability at that time. In some implementations, the user interface may set up notifications by posting streams. The system may allow a user (e.g., restaurant manager) to choose which guest on the interest list they want to send notifications. In some implementations, the user interface may provide the restaurant with all booking information 516. The user interface 500C may also show the booking list for a future time. This may provide additional options and allow the user better management capabilities.

In some implementations, the user interface may provide a method of allowing the user to alter the settings for the seating plan. The seating plan may allow a user to choose the number of diners and/or receive price updates from the restaurant and/or business entity. The seating plan may be connected to the cashier and/or point of sale system of the restaurant and/or business entity. The system may allow a restaurant and/or business entity to determine the number of courses they want to sell and provide recommended prices for the tickets based on supply and demand.

FIG. 5D illustrates a user interface 500D for selling a booking (e.g., posting a ticket) through a computing device according to the present disclosure. In some implementations, user interface may allow for selling tickets 518, viewing sold tickets, and/or checking for available and/or unavailable tickets. In some implementations, the system may allow the restaurants to create templates in how to provide information 520. In some implementations, the user interface may allow the system to sync the application with other booking and/or booking systems (e.g., Open Table, Seatme, Livebookings, etc.).

FIG. 5E illustrates a user interface 500E for selling a booking through a computing device according to the present disclosure. In some implementations, the ticket may contain the user and/or guest name 524, the name of the restaurant and/or business entity 522, and/or a code 526 (e.g., QR code, barcode, alpha/numeric code, etc.) containing the ticket information. Ticket information may include the time, date, area, number of diners, and/or any guest notes. Ticket information may be pulled from user profile information. In some implementations, the restaurant and guest may view different ticket information for the same bookings. For example, the restaurant may be able to view additional user profile information on the ticket so that they may provide better customer service during the user's dining experience. The user's ticket may contain information to provide the user with information they may find necessary to know when and where their booking takes place. In some implementations the user may be able to forward their ticket to others using email, SMS message, MMS message, and/or any other means of communication. The user interface may allow a user to print out a receipt for the kitchen.

FIG. 6 is a diagram for booking processes, including payment and peer-to-peer transfer, through a network environment 600, according to an exemplary embodiment as described in FIGS. 1 and 4. In some implementations, the system may allow the user to request a table. For example, in 601, if a first user wants to book a table at a restaurant, the user uses a client computing device to send a request over a network to the host server. In 602, the host server may then deliver the request to a booking module of a server of a restaurant. In 603, the restaurant server may identify and propose booking options including a reservation and/or a pre-paid ticket to the host server. In 604, the host server may transmit the offers to the client computing device of first user via push-notification (e.g., dashboard message with a status of offer available).

In some implementations, in 605, a second user uses a client computing device to create a subscription for the restaurant and sends the subscription request from the client computing device of the second user to the host server. In 606, the host server may create the subscription at the restaurant (e.g., by generating and storing a record for the subscription). In 607, the host server may then store the subscription for the second user. In 608, the client computing device of the second user is able to receive booking options for the subscribed timeframe.

In some implementations, a first user books a ticket. In 609, the first user uses the client computing device to pay for the ticket and manages the payment process by a credit card. In 610, the clearing company server may receive the payment data and clear the payment data. In 611, the clearing company server may create a virtual and/or e-wallet record or account for the first user and store the payment information. In 612, the clearing company server may transfer the payment amount to the host escrow wallet. In 613, the escrow wallet may keep the booking fee and create a cash-out. In 614, the host server may then transfer payment for the ticket from the escrow wallet to the restaurant e-wallet. In 615, the restaurant e-wallet may create a cash-out to their bank account. In 616, the client computing device of the first user may receive a report and status update from the host server that confirms the booking. In 617, the host server may transmit a status update the restaurant server. In 618, the host server may send a status update to the client computing device of the first user.

In some implementations, a first user may book a reservation. In 619, the first user's client computing device may be used to pay for a reservation and manage the payment process by credit card and/or any other method of payment. In 620, the clearing company server may verify the received payment data. In 621, the clearing company server may create a virtual e-wallet record or account for the first user and store the payment information. In 622, the clearing company server may transfer the booking fees to the host escrow wallet on the host server. In 623, the host server can create a cash-out for the escrow wallet. In 624, a report and status update are sent to the host server that the first user has confirmed a booking. In 625, the host server may create a report and status update that confirms the booking. In 626, the host server may transmit the status to the client computing device of the first user and the restaurant server.

In some implementations, the first user may transfer a ticket. In 627, the first user may use the client computing device to change the status of a ticket inside its booking list to cancel and transfer. In some implementations, in 628, the client computing device may transmit a status report to the host server as “in transfer.” In 629, the restaurant server may receive the change of the ticket status and become informed of the transfer process. In 630, the host ticket module of the host server may receive a change of status and automatically activate the search engine for a matching inquiry. In 631, a second user may be matched through a search and receive a transmission of a new ticket offer from the host ticket module.

In some implementations, the first user cancels a reservation. In 632, the first user may use the client computing device to change the status of a reservation inside its booking list to “cancel and transfer.” In some implementations, in 633, the client computing device transmits a status report to the host server so that the user profile may show “in transfer.” In 634, the restaurant server may receive a change of the ticket status and is informed about the cancelation. In 635, the host ticket module of the host server receives a change of status and automatically activates the search engine for a matching inquiry. In 636, the second user may be matched to the search and receive a new reservation offer from the host ticket module. In 637, the restaurant may have other potential guests for the booking and may manually or automatically delete the offer of the first user.

In some implementations, a second user may book a transferred ticket. In 638, the second user may use the client computing device to pay for a ticket and manage the payment process by a credit card and/or any other form of payment. In 639, a clearing company server may clear the received payment data. In 640, the clearing company server may create a virtual e-wallet record or account for the second user and store the payment information. In 641, the clearing company server may transfer the payment amount to the host escrow wallet. In 642, the escrow wallet may keep the booking fee and the host server can create a cash-out. In 643, the host server may transfer a refund for the ticket from the escrow wallet to the first user's e-wallet. In 644, the host serve r may create a report and transmit an update to the first user client computing device with a “refund successful” status. In 645, the host server reports a status update to the first user client computing device with a “transferred’ status. In 646, the first user client computing device is able to crate a cash-out for the refund. In 647, status updates of a successfully transferred ticket are transmitted to the host. In 648, the host server may inform the restaurant server of the second user being the new ticket holder. In 649, the host server may additionally inform the second user about the purchased ticket and successful payment. The second user may receive a report and status update from the host which confirms the booking. The host may update the restaurant.

Unless specifically stated otherwise as apparent from the following discussion, it is appreciated that throughout the description, discussions utilizing terms such as “processing” or “computing” or “calculating” or “determining” or “measuring” or “selecting” or “displaying” or “identifying” or “detecting” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The exemplary embodiments can relate to an apparatus for performing one or more of the functions described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk including floppy disks, optical disks, CD-ROMs and magnetic-optical disks, read only memories (ROMs), random access memories (RAMs) erasable programmable ROMs (EPROMs), electrically erasable programmable ROMs (EEPROMs), magnetic or optical cards, or any type of media suitable for storing electronic instructions, and each coupled to a bus.

The exemplary embodiments described herein are described as software executed on at least one server, though it is understood that embodiments can be configured in other ways and retain functionality. The embodiments can be implemented on known devices such as a personal computer, a special purpose computer, cellular telephone, personal digital assistant (“PDA”), a digital camera, a digital tablet, an electronic gaming system, a programmed microprocessor or microcontroller and peripheral integrated circuit element(s), and ASIC or other integrated circuit, a digital signal processor, a hard-wired electronic or logic circuit such as a discrete element circuit, a programmable logic device such as a PLD, PLA, FPGA, PAL, or the like. In general, any device capable of implementing the processes described herein can be used to implement the systems and techniques according to this invention.

It is to be appreciated that the various components of the technology can be located at distant portions of a distributed network and/or the Internet, or within a dedicated secure, unsecured and/or encrypted system. Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine.

Furthermore, it should be appreciated that the various links connecting the elements can be wired or wireless links, or any combination thereof, or any other known or later developed element(s) that is capable of supplying and/or communicating data to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

The embodiments described above are intended to be exemplary. One skilled in the art recognizes that there are numerous alternative components and embodiments that may be substituted for or included in the particular examples described herein and such additions or substitutions still fall within the scope of the invention.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate or transport a program for use by or in connection with an instruction execution system, apparatus or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. Other types of programming languages include HTML5, Flash and other similar languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality and operation of possible implementations of systems, methods and computer program products according to various embodiments of the present disclosure. In this regard, each block in the flowchart or block diagrams may represent a module, segment or portion of code, which comprises one or more executable instructions for implementing the specified logical function(s). It should also be noted that, in some alternative implementations, the functions noted in the block might occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The flow diagrams depicted herein are just one example. There may be many variations to this diagram or the steps (or operations) described therein without departing from the spirit of the disclosure. For instance, the steps may be performed in a differing order or steps may be added, deleted or modified. All of these variations are considered a part of the claimed disclosure.

While the preferred embodiment to the disclosure had been described, it will be understood that those skilled in the art, both now and in the future, may make various improvements and enhancements which fall within the scope of the claims which follow. These claims should be construed to maintain the proper protection for the disclosure first described.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A computer-implemented method comprising:
storing, by a host server in a ticket database, information related to a plurality of restaurants comprising tickets corresponding to reservations at restaurants, the reservations containing time and date information, the tickets containing an available status or an unavailable status;
receiving, by the host server, a request from the first user computing device to purchase a ticket with an available status, the ticket corresponding to a reservation at a restaurant, the ticket containing time and date information;
upon receiving a transmission of payment instructions from the first user computing device, associating, by the host server, the ticket with the first user in the ticket database and changing the status of the ticket to unavailable;
transmitting, by the host server to the first user computing device, the ticket to the first user;
changing, by the host server, the status of the ticket in the ticket database to an unavailable status;
receiving, by the host server from the first user computing device, a request to change the status of the ticket from unavailable to available in the ticket database;
changing, by the host server, the status of the ticket from unavailable to available in the ticket database;
receiving, by the host server, a request from a second user computing device to purchase the ticket;
upon receiving a transmission of payment instructions from the second user computing device, associating, by the host server, the ticket with the second user in the ticket database and changing the status of the ticket to unavailable; and
crediting, by the host server, at least a portion of the payment from the first user for the ticket to the first user computing device.

2. The method of claim 1, further comprising:
receiving, by the host server from the first user computing device, a location of a first user;
searching, by the host server in the ticket database, for tickets with an available status corresponding to the reservations at restaurants in a vicinity of the location; and
transmitting, by the host server on the display of the first user computing device, the tickets with the available status.

3. The method of claim 2, wherein receiving the location of the first user is based on a global positioning system.

4. The method of claim 2, wherein receiving the location is based on user input.

5. The method of claim 1, further comprising sending push notifications to a plurality of users containing information related to tickets with an available status.

6. The method of claim 5, wherein push notifications are sent based on targeting users based on their user profile.

7. The method of claim 1, wherein the first user resells the ticket to the second user and receives a commission.

8. The method of claim 1, wherein the system resells the ticket to the second user and first user pays a booking fee.

9. A computer-implemented method comprising:
storing, by a host server in a ticket database, information related to tickets corresponding to events at a business, the events containing time and date information, the tickets containing an available status or an unavailable status, and storing, in a customer database, profile information for users that have purchased tickets;
searching, by the host server, tickets in the ticket database with the available status during a predetermined period of time;
receiving, by the host server from the entity server, a list of tickets with the available status and tickets with the unavailable status;
searching, by the host server in the customer database, profile information for users that did not purchase tickets during the predetermined period of time; and
posting, by the host server, tickets with the available status and sending push notifications to the computing devices of users that did not purchase tickets during the predetermined period of time regarding the tickets with the available status during the predetermined period of time.

10. The method of claim 9, further comprising:
receiving, by the host server from a first user computing device, a request from a first user to purchase a ticket with an available status;
determining, by the host server, the cost of the ticket;
upon receiving payment from the first user computing device, associating, by the host server, the ticket with the first user in the ticket database and changing the status of the ticket to unavailable;
transmitting, by the host server to the first user computing device, the ticket to the first; and
changing, by the host server, the status of the ticket in the ticket database to an unavailable status.

11. The method of claim 10, wherein the request to purchase the ticket comprises: the price of the tickets and an additional booking fee.

12. The method of claim 10, wherein the cost is based on the time the ticket was purchased or the type of user which purchased the ticket.

13. The method of claim 12, wherein time based purchases comprises: early bird, last minute, and number of tickets purchased during a time period.

14. The method of claim 12, wherein the type of user comprises: concierges, subscribers, business travelers, culinary professionals, and journalists.

15. The method of claim 9, further comprises: determining the location of the users and sending push notifications to a plurality of users containing information related to tickets with an available status when the users are within a proximate vicinity of the business during the predetermined period of time.

16. The method of claim 15, wherein push notifications consist of sending incentives comprising: points, coupons, and virtual currency.

17. The method of claim 15, wherein push notifications are sent based on targeting users based on their user profile.

18. A computer-implemented method comprising:
storing, by a host server, in a ticket database, information related to a plurality of businesses comprising tickets corresponding to events at the businesses, the events containing time and date information, the tickets containing an available status or an unavailable status;
receiving, by the host server from the first user computing device, a request to purchase a ticket with an available status within a timeframe determined by the first user, the ticket corresponding to an event at a business, the ticket containing time and date information;
upon identifying a ticket in the ticket database with an available status for a time within the timeframe and upon receiving a transmission of payment instructions from the first user computing device, associating, by the host server, the ticket with an available status within the timeframe with the first user in the ticket database and changing the status of the ticket to unavailable;
transmitting, by the host server to the first user computing device, the ticket to the first user;
changing, by the host server, the status of the ticket in the ticket database to an unavailable status;
receiving, by the host server from the first user computing device, a request to change the status of the ticket from unavailable to available in the ticket database;
changing, by the host server, the status of the ticket from unavailable to available in the ticket database;
upon changing the status of the ticket to available, automatically posting by the host server to computing devices of users, the ticket with the available status;
receiving, by the host server, a request from a second user computing device to purchase the ticket;
upon receiving a transmission of payment instructions from the second user computing device, associating, by the host server, the ticket with the second user in the ticket database and changing the status of the ticket to unavailable; and
crediting, by the host server, at least a portion of the payment from the first user for the ticket to the first user computing device.

19. The method of claim 18, wherein the business is one or more of: a restaurant, a tour guide, a bowling alley, a movie theater, a hotel, a rail-line, and an airline.

20. The method of claim 18, further comprises: determining the location of the users and sending push notifications to a plurality of users containing information related to tickets with an available status when the users are within a proximate vicinity of the business during the predetermined period of time.

21. The method of claim 18, storing a search query for the request for the user and transmitting a message to the user comprising a response to the search query.
